(19) United States
(12) Patent Application Publication
(10) Pub. No.: US 2024/0368317 A1
(43) Pub. Date: Nov. 7, 2024

(54) POLYMERISATION OF PROPYLENE

(71) Applicant: Oxford University Innovation Limited, Oxford (GB)

(72) Inventors: Dermot O'HARE, Oxford (GB); Jean-Charles BUFFET, Oxford (GB); Zoe TURNER, Oxford (GB); Clement COLLINS RICE, Oxford (GB)

(21) Appl. No.: 18/558,372

(22) PCT Filed: May 6, 2022
(86) PCT No.: PCT/GB2022/051161

§ 371 Date: Nov. 1, 2023

(30) Foreign Application Priority Data
May 7, 2021 (GB) 2106577.6

(51) Int. Cl. C08F 110/06

(52) U.S. Cl. CPC C08F 110/06; C08F 2420/07

(57) ABSTRACT

A process for the polymerisation of propylene is described, in which the resulting polypropylene is high molecular weight atactic polypropylene. Also described is high molecular weight and ultra-high molecular weight atactic polypropylene.

### INTRODUCTION

The present invention relates to a process for the preparation of a polypropylene. More particularly, the invention relates to a process for preparing atactic polypropylene.

### BACKGROUND OF THE INVENTION

It is known that α-olefins, notably ethylene, can be readily polymerised at low or medium pressures in the presence of certain transition metal catalysts. These catalysts are generally known as Zeigler-Natta type catalysts.

A particular group of these Ziegler-Natta type catalysts, which catalyse the polymerisation of α-olefins, comprise a metallocene transition metal catalyst often in combination with an aluminoxane activator. Metallocenes comprise a metal bound between two η⁵-cyclopentadienyl type ligands.

Polypropylene has innumerable industrial uses. Commercial polypropylene is usually isotactic or syndiotactic, which can be readily produced in a range of molecular weights. Low molecular weight “atactic” polypropylene is obtained as a byproduct in the industrial production of isotactic polypropylene, finding applications as an additive in bitumens and hot-melt adhesives. However, rather than being truly atactic, this product is actually composed of a mixture of polymer chains of different tacticities and molecular weights. Given the development of industrial catalysts having improved stereospecificity for isotactic and syndiotactic polypropylene, the availability of atactic polypropylene is reducing. Nevertheless, there remains industrial interest in amorphous polypropylenes.

Accordingly, there is a need for catalysts capable of producing atactic polypropylene, in particular that having high molecular weight, under mild, industrially-attractive, conditions.

The present invention was devised with the foregoing in mind.

### SUMMARY OF THE INVENTION

According to a first aspect of the present invention there is provided a process for the preparation of a polypropylene, the process comprising contacting propylene with a compound having a structure according to Formula I shown below:

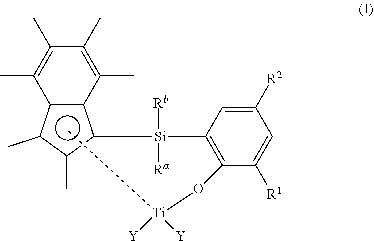

wherein

R¹ and R² are each independently selected from the group consisting of hydrogen, (1-6C)alkyl, (1-6C)haloalkyl, (1-6C)alkoxy, (2-6C)alkenyl, (2-6C)alkynyl, —NR³R⁴ and —(O)ₙ—(CR⁵R⁶)ₘ—R⁷, where n is 0 or 1, m is 0 or 1, R³ and R⁴ are independently selected from hydrogen and (1-3C)alykyl, R⁵ and R⁶ are each independently hydrogen or (1-2C)alykyl, and R⁷ is selected from the group consisting of aryl, heteroaryl, carbocyclyl and heterocyclyl, and where each R⁷ is independently optionally substituted with one or more groups R⁸ selected from the group consisting of halo, hydroxy, (1-4C)alykyl, (1-4C)haloalkyl and (1-3C)alykoxy;

R^{a} and R^{b} are each independently selected from (1-4C)alykyl, (2-4C)alykenyl and aryl; and

each Y is independently selected from the group consisting of hydride, halo, (1-5C)alykyl, (1-5C)alykoxy, —(CH₂)ₚSi(R⁹)₃, —NR¹⁰R¹¹, and —(O)_{q}—(CR¹²R¹³), —R¹⁴, where p is 1 or 2, q is 0 or 1, r is 0 or 1, each R⁹ is independently (1-3C)alykyl, R¹⁰ and R¹¹ are independently selected from hydrogen and (1-3C)alykyl, R¹² and R¹³ are independently selected from hydrogen and (1-2C)alykyl, and R¹⁴ is selected from the group consisting of aryl, heteroaryl, carbocyclyl and heterocyclyl, and where each R¹⁴ is independently optionally substituted with one or more groups R¹⁵ selected from the group consisting of halo, hydroxy, (1-4C)alykyl, (1-4C)haloalkyl and (1-3C)alykoxy.

According to a second aspect of the present invention there is provided a process for the preparation of a polypropylene, the process comprising contacting propylene with a compound having a structure according to Formula I shown below:

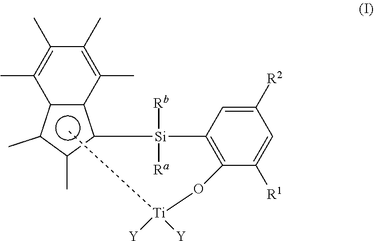

wherein

R¹ and R² are each independently selected from the group consisting of hydrogen, (1-6C)alykyl, (1-6C)haloalkyl, (1-6C)alykoxy, (2-6C)alykenyl, (2-6C)alykynyl, —NR³R⁴ and —(O), —(CR⁵R⁶)ₘ—R⁷, where n is 0 or 1, m is 0 or 1, R³ and R⁴ are independently selected from hydrogen and (1-3C)alykyl, R⁵ and R⁶ are each independently hydrogen or (1-2C)alykyl, and R⁷ is selected from the group consisting of aryl, heteroaryl, carbocyclyl and heterocyclyl, and where each R⁷ is independently optionally substituted with one or more groups R⁸ selected from the group consisting of halo, hydroxy, (1-4C)alykyl, (1-4C)haloalkyl and (1-3C)alykoxy;

R^{a} and R^{b} are each independently selected from (1-4C)alykyl and (2-4C)alykenyl; and

each Y is independently selected from the group consisting of hydride, halo, (1-5C)alykyl, (1-5C)alykoxy, —(CH₂)ₚSi(R⁹)₃, —NR¹⁰R¹¹, and —(O)_{q}—(CR¹²R¹³)ᵣ—R¹⁴, where p is 1 or 2, q is 0 or 1, r is 0 or 1, each R⁹ is independently (1-3C)alykyl, R¹⁰ and R¹¹ are independently selected from hydrogen and (1-3C)alykyl, R¹² and R¹³ are independently selected from hydrogen and (1-2C)alykyl, and R¹⁴ is selected from the group consisting of aryl, heteroaryl, carbocyclyl and heterocyclyl, and where each R¹⁴ is independently optionally substituted with one or more groups R¹⁵ selected from the group consisting of halo, hydroxy, (1-4C)alykyl, (1-4C)haloalkyl and (1-3C)alykoxy.

According to a third aspect of the present invention there is provided atactic polypropylene having a molecular weight (M_{w}) greater than 500,000 g mol⁻¹.

According to a fourth aspect of the present invention there is provided polypropylene obtained, directly obtained or obtainable by the process of the first or second aspect.

According to a fifth aspect of the present invention there is provided a compound having a structure according to Formula I defined herein.

### DETAILED DESCRIPTION OF THE INVENTION

### Definitions

The term “(m-nC)” or “(m-nC) group” used alone or as a prefix, refers to any group having m to n carbon atoms.

In this specification the term “alkyl” includes both straight and branched chain alkyl groups. References to individual alkyl groups such as “propyl” are specific for the straight chain version only and references to individual branched chain alkyl groups such as “isopropyl” are specific for the branched chain version only. For example, “(1-6C)alykyl” includes (1-4C)alykyl, (1-3C)alykyl, propyl, isopropyl and t-butyl.

The term “alkenyl” refers to straight and branched chain alkyl groups comprising 2 or more carbon atoms, wherein at least one carbon-carbon double bond is present within the group. Examples of alkenyl groups include ethenyl, propenyl and but-2,3-enyl and includes all possible geometric (E/Z) isomers.

The term “alkynyl” refers to straight and branched chain alkyl groups comprising 2 or more carbon atoms, wherein at least one carbon-carbon triple bond is present within the group. Examples of alkynyl groups include acetylenyl and propynyl.

The term “alkoxy” refers to O-linked straight and branched chain alkyl groups. Examples of alkoxy groups include methoxy, ethoxy and t-butoxy.

The term “haloalkyl” is used herein to refer to an alkyl group in which one or more hydrogen atoms have been replaced by halogen (e.g. fluorine) atoms. Often, haloalkyl is fluoroalkyl. Examples of haloalkyl groups include —CH₂F, —CHF₂ and —CF₃. Most often, haloalkyl is —CF₃.

The term “halo” or “halogeno” refers to fluoro, chloro, bromo and iodo, suitably fluoro, chloro and bromo, more suitably, fluoro and chloro. Most suitably, halo is chloro.

The term “carbocyclyl”, “carbocyclic” or “carbocycle” means a non-aromatic saturated or partially saturated monocyclic, fused, bridged, or spiro bicyclic carbon-containing ring system(s). Examples of carbocyclic groups include cyclopropyl, cyclobutyl, cyclohexyl, cyclohexenyl and spiro[3.3]heptanyl.

The term “heterocyclyl”, “heterocyclic” or “heterocycle” means a non-aromatic saturated or partially saturated monocyclic, fused, bridged, or spiro bicyclic heterocyclic ring system(s) incorporating one or more (for example 1-4, particularly 1, 2 or 3) heteroatoms selected from nitrogen, oxygen or sulfur. Examples of heterocycles include azetidinyl, pyrrolidinyl, piperidinyl, piperazinyl, tetrahydrotriazinyl, tetrahydropyrazolyl, and the like.

The term “aryl” or “aromatic” as used herein means an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The term “heteroaryl” or “heteroaromatic” means an aromatic mono-, bi-, or polycyclic ring incorporating one or more (for example 1-4, particularly 1, 2 or 3) heteroatoms selected from nitrogen, oxygen or sulfur. Examples of five membered heteroaryl groups include but are not limited to pyrrolyl, furanyl, thienyl, imidazolyl, furazanyl, oxazolyl, oxadiazolyl, oxatriazolyl, isoxazolyl, thiazolyl, isothiazolyl, pyrazolyl, triazolyl and tetrazolyl groups. Examples of six membered heteroaryl groups include but are not limited to pyridyl, pyrazinyl, pyridazinyl, pyrimidinyl and triazinyl.

The term “substituted” as used herein in reference to a moiety means that one or more, especially up to 5, of the hydrogen atoms in said moiety are replaced independently of each other by the corresponding number of the described substituents. Preferably, “substituted” as used herein in reference to a moiety means that 1, 2 or 3, of the hydrogen atoms in said moiety are replaced independently of each other by the corresponding number of the described substituents. Even more preferred, “substituted” as used herein in reference to a moiety means that 1 or 2, of the hydrogen atoms in said moiety are replaced independently of each other by the corresponding number of the described substituents. The term “optionally substituted” as used herein means substituted or unsubstituted.

It will, of course, be understood that substituents may only be at positions where they are chemically possible, the person skilled in the art being able to decide (either experimentally or theoretically) without inappropriate effort whether a particular substitution is possible.

Throughout the entirety of the description and claims of this specification, where subject matter is described herein using the term “comprise” (or “comprises” or “comprising”), the same subject matter instead described using the term “consist of” (or “consists of” or “consisting of”) or “consist essentially of” (or “consists essentially of” or “consisting essentially of”) is also contemplated.

Throughout the description and claims of this specification, the singular encompasses the plural unless the context otherwise requires. In particular, where the indefinite article is used, the specification is to be understood as contemplating plurality as well as singularity, unless the context requires otherwise.

Features described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any of the specific embodiments recited herein. The invention extends to any novel one, or any novel combination, of the features disclosed in this specification (including any accompanying claims, abstract and drawings), or to any novel one, or any novel combination, of the steps of any method or process so disclosed.

Unless otherwise specified, where the quantity or concentration of a particular component of a given product is specified as a weight percentage (wt. % or % w/w), said weight percentage refers to the percentage of said component by weight relative to the total weight of the product as a whole. It will be understood by those skilled in the art that the sum of weight percentages of all components of a product will total 100 wt. %. However, where not all components are listed (e.g. where a product is said to “comprise” one or more particular components), the weight percentage balance may optionally be made up to 100 wt % by unspecified ingredients.

### Polymerisation of Propylene

According to a first aspect of the present invention there is provided a process for the preparation of a polypropylene, the process comprising contacting propylene with a compound having a structure according to Formula I shown below:

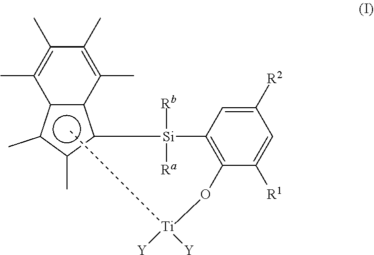

wherein

R¹ and R² are each independently selected from the group consisting of hydrogen, (1-6C)alykyl, (1-6C)haloalkyl, (1-6C)alykoxy, (2-6C)alykenyl, (2-6C)alykynyl, —NR³R⁴ and —(O)ₙ—(CR⁵R⁶)ₘ—R⁷, where n is 0 or 1, m is 0 or 1, R³ and R⁴ are independently selected from hydrogen and (1-3C)alykyl, R⁵ and Re are each independently hydrogen or (1-2C)alykyl, and R⁷ is selected from the group consisting of aryl, heteroaryl, carbocyclyl and heterocyclyl, and where each R⁷ is independently optionally substituted with one or more groups R⁸ selected from the group consisting of halo, hydroxy, (1-4C)alykyl, (1-4C)haloalkyl and (1-3C)alykoxy;

R^{a} and R^{b} are each independently selected from (1-4C)alykyl, (2-4C)alykenyl and aryl; and

each Y is independently selected from the group consisting of hydride, halo, (1-5C)alykyl, (1-5C)alykoxy, —(CH2)ₚSi(R⁹)₃, —NR¹⁰R¹¹, and —(O)_{q}—(CR¹²R¹³), —R¹⁴, where p is 1 or 2, q is 0 or 1, r is 0 or 1, each R⁹ is independently (1-3C)alykyl, R¹⁰ and R¹¹ are independently selected from hydrogen and (1-3C)alykyl, R¹² and R¹³ are independently selected from hydrogen and (1-2C)alykyl, and R¹⁴ is selected from the group consisting of aryl, heteroaryl, carbocyclyl and heterocyclyl, and where each R¹⁴ is independently optionally substituted with one or more groups R¹⁵ selected from the group consisting of halo, hydroxy, (1-4C)alykyl, (1-4C)haloalkyl and (1-3C)alykoxy.

Through rigorous investigations, the inventors have devised new compounds that serve as highly active procatalysts in the polymerisation of propylene to produce high molecular weight (i.e. M_{w}>200,000 g mol⁻¹) and ultra-high molecular weight (i.e. >1,000,000 g mol⁻¹) atactic polypropylene having low polydispersity, thereby addressing the aforementioned shortcomings in the state of the art. Moreover, the present process allows the molecular weight of the resulting polypropylene to be straightforwardly tuned according to the intended application of the end polymer, thereby affording greater industrial flexibility.

The following passages discuss the compounds of Formula (I) in more detail and are applicable to both the first and second aspects of the invention.

R¹ and R² may each independently selected from the group consisting of hydrogen, (1-5C)alykyl, (1-5C)alykoxy and —(O), —(CR⁵R⁶)ₘ—R⁷. Suitably, R¹ and R² are each independently selected from the group consisting of hydrogen, (1-4C)alykyl and —(O)ₙ—(CR⁵R⁶)ₘ—R⁷.

R⁷ may be selected from the group consisting of aryl and heteroaryl. Suitably, R⁷ is selected from the group consisting of phenyl and 5-6 membered heteroaryl, wherein said 5-6 membered heteroaryl contains 1 or 2 nitrogen heteroatoms. Most suitably, R⁷ is phenyl. R⁷ may be independently optionally substituted with one or more groups R⁸.

R⁸ may be selected from the group consisting of halo and (1-3C)alykyl.

In particular embodiments, R¹ and R² are each independently selected from the group consisting of hydrogen, methyl, tert-butyl and —C(CH₃)₂Ph, where Ph denotes phenyl. Suitably, R¹ and R² are each independently selected from the group consisting of methyl, tert-butyl and —C(CH₃)₂Ph. Particular non-limiting examples include: (i) R¹ is tert-butyl and R² is methyl; (ii) R¹ and R² are both tert-butyl; and (iii) R¹ and R² are both —C(CH₃)₂Ph, of which example (ii) is especially suitable.

R^{a} and R^{b} may be independently selected from (1-3C)alykyl and aryl, particular examples of which include methyl, n-propyl and phenyl. For example, R^{a} and R^{b} may be methyl and methyl respectively, or methyl and n-propyl respectively, or methyl and phenyl respectively.

R^{a} and R^{b} may be independently selected from (1-3C)alykyl, particular examples of which include methyl and n-propyl. Suitably, both R^{a} and R^{b} are identical. More suitably, R^{a} and R^{b} are both methyl.

Each Y may be independently selected from the group consisting of hydride, chloro, bromo, iodo, (1-3C)alykyl, (1-3C)alykoxy, —(CH₂)ₚSi(R⁹)₃, —NR¹⁰R¹¹, and —(O)_{q}—(CR¹²R¹³), —R¹⁴.

Suitably, p is 1 and R⁹ is methyl.

R¹⁰ and R¹¹ may be independently selected from (1-3C)alykyl, in particular methyl.

R¹² and R¹³ may be hydrogen.

R¹⁴ may be selected from the group consisting of aryl and heteroaryl. Suitably, R¹⁴ is selected from the group consisting of phenyl and 5-6 membered heteroaryl, wherein said 5-6 membered heteroaryl contains 1 or 2 nitrogen heteroatoms. Most suitably, R¹⁴ is phenyl. R¹⁴ may be independently optionally substituted with one or more groups R¹⁵, each of which is suitably independently selected from the group consisting of (1-4C)alykyl.

Particular non-limiting examples of the group —(O)—(CR¹²R¹³)ᵣ—R¹⁴ include:

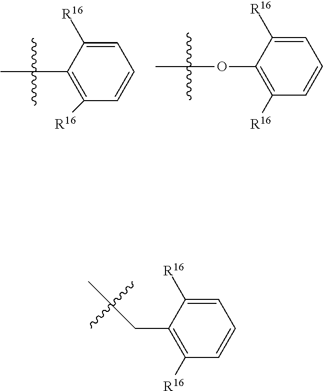

wherein each R¹⁶ is independently selected from hydrogen and R¹⁵.

In particular embodiments, each Y is independently selected from the group consisting of chloro, bromo, iodo, methyl, —CH₂Si(CH₃)₃, —N(CH₃)₂ and —O-2,6-diisopropylphenyl. Suitably, each Y is independently selected from the group consisting of chloro, bromo, iodo and methyl. More suitably, both Y are identical.

In particularly suitable embodiments, Y is chloro.

In certain embodiments, the compound of Formula I has a structure according to Formula I-A shown below:

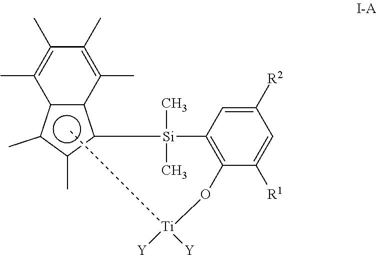

wherein R¹, R² and Y are as defined hereinbefore.

In certain embodiments, the compound of Formula I has a structure according to Formula I-B shown below:

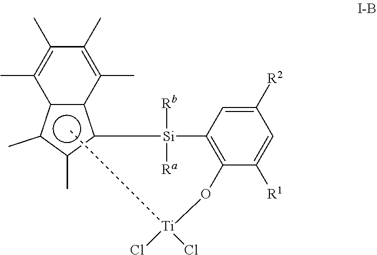

wherein R¹, R², R^{a} and R^{b} are as defined hereinbefore.

In certain embodiments, the compound of Formula I has a structure according to Formula I-C shown below:

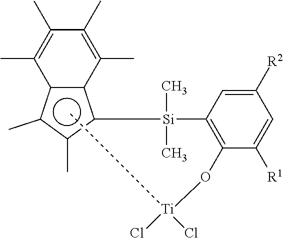

wherein R¹ and R² are as defined hereinbefore.

In certain embodiments, the compound of Formula I has one of the following structures:

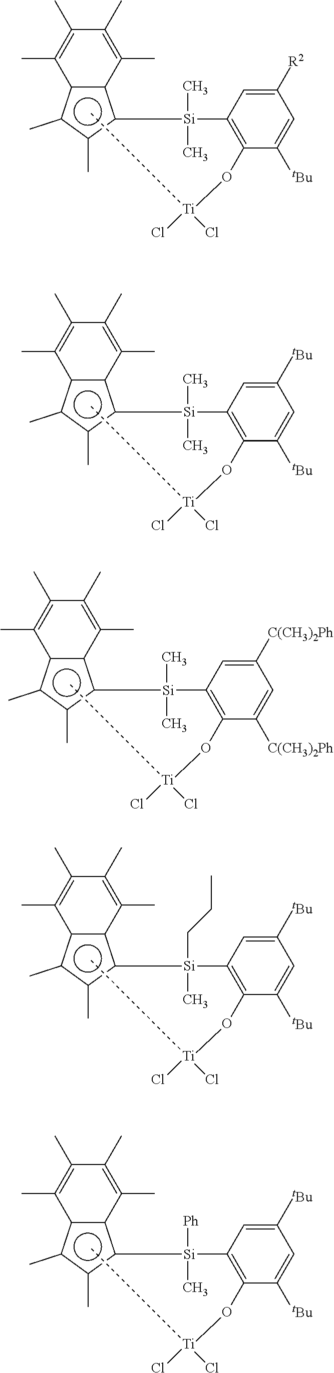

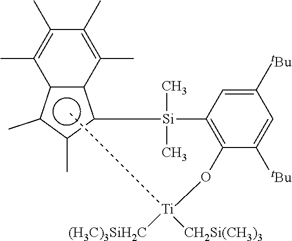

wherein ^{t}Bu denotes tert-butyl and Ph denotes phenyl.

The compound of Formula (I) may be associated with (e.g. immobilised on or supported on) a supporting substrate. Suitably, the supporting substrate is a solid. It will be appreciated that the compound may be immobilised on the supporting substrate by one or more covalent or ionic interactions, either directly, or via a suitable linking moiety. It will be appreciated that minor structural modifications resulting from the immobilisation of the compound of the supporting substrate (e.g. loss of one or both groups, Y) are nonetheless within the scope of the invention.

Suitably, the supporting substrate is selected from solid polymethylaluminoxane, silica-supported methylaluminoxane, alumina, zeolite, layered double hydroxide and layered double hydroxide-supported methylaluminoxane.

More suitably, the supporting substrate is solid polymethylaluminoxane. The mole ratio of Al in the solid polymethylaluminoxane supporting substrate to metal X in the compound of formula I (i.e. [Alₛᵤₚₚₒᵣₜ]/[X]) may be 50:1 to 400:1, and is suitably 150:1 to 250:1.

The terms “solid MAO”, “sMAO” and “solid polymethylaluminoxane” are used synonymously herein to refer to a solid-phase material having the general formula —[(Me)AlO]ₙ—, wherein n is an integer from 4 to 50 (e.g. 10 to 50). Any suitable solid polymethylaluminoxane may be used.

There exist numerous substantial structural and behavioural differences between solid polymethylaluminoxane and other, conventional MAOs. Perhaps most notably, solid polymethylaluminoxane is distinguished from other MAOs by virtue of its insolubility in many hydrocarbon solvents and so acts as a heterogeneous support system. In contrast to conventional, hydrocarbon-soluble MAOs, which are traditionally used as an activator species in slurry polymerisation or to modify the surface of a separate solid supporting substrate (e.g. SiO₂), the solid polymethylaluminoxanes useful as part of the present invention are themselves suitable for use as solid-phase supporting substrates. Hence, solid polymethylaluminoxane supporting substrates used as part of the present invention are devoid of any other species that could be considered a solid supporting substrate (e.g. inorganic material such as SiO₂, Al₂O₃ and ZrO₂). Moreover, given the dual function of the solid polymethylaluminoxane (as catalytic supporting substrate and activator species), compounds of the invention supported on solid polymethylaluminoxane may not require the presence of an additional catalytic activator species (e.g. TIBA) when used in olefin polymerisation reactions.

Solid polymethylaluminoxane may be prepared by heating a solution containing MAO and a hydrocarbon solvent (e.g. toluene), so as to precipitate solid polymethylaluminoxane. The solution containing MAO and a hydrocarbon solvent may be prepared by reacting trimethyl aluminium and benzoic acid in a hydrocarbon solvent (e.g. toluene), and then heating the resulting mixture.

The aluminium content of the solid polymethylaluminoxane suitably falls within the range of 36-41 wt %.

The solid polymethylaluminoxane useful as part of the present invention is characterised by extremely low solubility in toluene and n-hexane. In an embodiment, the solubility in n-hexane at 25° C. of the solid polymethylaluminoxane is 0-2 mol %. Suitably, the solubility in n-hexane at 25° C. of the solid polymethylaluminoxane is 0-1 mol %. More suitably, the solubility in n-hexane at 25° C. of the solid polymethylaluminoxane is 0-0.2 mol %. Alternatively or additionally, the solubility in toluene at 25° C. of the solid polymethylaluminoxane is 0-2 mol %. Suitably, the solubility in toluene at 25° C. of the solid polymethylaluminoxane is 0-1 mol %. More suitably, the solubility in toluene at 25° C. of the solid polymethylaluminoxane is 0-0.5 mol %. The solubility in solvents can be measured by the method described in JP-B (KOKOKU)-H07 42301.

In a particularly suitable embodiment, the solid polymethylaluminoxane is as described in WO2010/055652 or WO2013/146337, and is obtainable from Tosoh Finechem Corporation, Japan.

The process may be conducted in the presence of an activator or co-catalyst. Suitably, the activator or co-catalyst is one or more organoaluminium compounds. More suitably, the one or more organoaluminium compounds is an alkylaluminium compound. Exemplary alkylaluminium compounds include methylaluminoxane, triisobutylaluminium, trimethylaluminium and triethylaluminium. Most suitably, the organoaluminium compound is methylaluminoxane. Suitably, the mole ratio of Al in the organoaluminium compound to metal X in the compound of formula I (i.e. [Al_{co-cat}]/[X]) may be 200:1 to 5000:1. Suitably, [Al_{co-cat}]/[X] is 1000:1 to 5000:1.

The polypropylene produced by the process is atactic. Suitably, the polypropylene has a molecular weight (M_{w}) of >200,000 g mol⁻. More suitably, the polypropylene has a molecular weight (M_{w}) of >400,000 g mol⁻¹. Even more suitably, the polypropylene has a molecular weight (M_{w}) of >600,000 g mol⁻¹. Yet more suitably, the polypropylene has a molecular weight (M_{w}) of >800,000 g mol⁻¹. Yet even more suitably, the polypropylene has a molecular weight (M_{w}) of >1,000,000 g mol⁻¹. Most suitably, the polypropylene has a molecular weight (M_{w}) of >1,200,000 g mol⁻¹.

The compound of Formula (I) may be unsupported, in which case the polymerisation process is conducted in solution phase. Alternatively, the compound of Formula I may be supported on a supporting substrate, in which case the polymerisation process is conducted in slurry phase. Any suitable solvent may be used in either process. Suitably, the solvent is a nonpolar, nonaromatic hydrocarbon solvent. More suitably, the solvent is hexane.

The person of ordinary skill in the art will be able to select appropriate conditions (e.g. temperature, pressure etc) for conducting the polymerisation process. Suitably, the process may be conducted at a temperature of 5 to 90° C. More suitably, the process is conducted at a temperature of 30 to 75° C.

The polypropylene is suitably a homopolymer. Alternatively, the polypropylene may be a polypropylene-containing copolymer, in which case the process comprises contacting propylene and another (4-10C)α-olefin with a compound having a structure according to Formula (I). Suitably, the quantity of propylene and the other aαolefin used in the process are such that greater than 90% of the repeating units within the resulting copolymer are derived from the polymerisation of propylene.

In a fifth aspect, the present invention provides compounds of Formula I as defined herein. It will be understood that compounds according to the fifth aspect may have any of those definitions outlined herein in relation to the first and second aspects.

### High Molecular Weight Atactic Polypropylene

According to a third aspect of the present invention there is provided atactic polypropylene having a molecular weight (Mw) greater than 500,000 g mol⁻¹.

The propylene polymerisation processes of the invention provides a solution to the problem of accessing true atactic polypropylene having high molecular weight.

The term “atactic polypropylene” will be clear to one of ordinary skill in the art as denoting a polypropylene homopolymer in which the pendant methyl groups are randomly orientated on both sides of the polymer chain along its length.

The atactic polypropylene of the invention has a degree of crystallinity, when analysed by differential scanning calorimetry (DSC), of <15%.

Most suitably, the atactic polypropylene of the invention has a degree of crystallinity of <1% (e.g., is amorphous) when analysed by DSC and/or has no detectable melting enthalpy (ΔH_{f}) when analysed by DSC.

The atactic polypropylene of the invention suitably has a Pᵣ of 0.25-0.75 as determined by ¹³C NMR using Bernouillan statistics. More suitably, Pᵣ is 0.45-0.55.

The molecular weight (Mw) of the atactic polypropylene was determined by gel permeation chromatography (GPC). The atactic polypropylene of the invention may have a molecular weight (M_{w}) greater than 600,000 g mol⁻¹. Suitably, the atactic polypropylene has a molecular weight (M_{w}) greater than 700,000 g mol⁻¹. More suitably, the atactic polypropylene has a molecular weight (M_{w}) greater than 800,000 g mol⁻¹. Even more suitably, the atactic polypropylene has a molecular weight (M_{w}) greater than 900,000 g mol⁻¹. Yet even more suitably, the atactic polypropylene has a molecular weight (M_{w}) greater than 1,000,000 g mol⁻¹. Yet even more suitably, the atactic polypropylene has a molecular weight (M_{w}) greater than 1, 100,000 g mol⁻¹. Yet even more suitably, the atactic polypropylene has a molecular weight (M_{w}) greater than 1,200,000 g mol⁻¹. Most suitably, the atactic polypropylene has a molecular weight (M_{w}) greater than 1,300,000 g mol⁻¹.

The polydispersity index (PDI) of the atactic polypropylene is suitably less than 3.0. More suitably, the PDI of the atactic polypropylene is suitably less than 2.8. Even more suitably, the PDI of the atactic polypropylene is less than 2.6. Yet more suitably, the PDI of the atactic polypropylene is less than 2.4. Yet even more suitably, the PDI of the atactic polypropylene is less than 2.2.

In a particular embodiment, the atactic polypropylene has a molecular weight (M_{w}) greater than 800,000 g mol⁻¹ and a PDI dispersity of less than 2.6.

In a particular embodiment, the atactic polypropylene has a molecular weight (M_{w}) greater than 1,200,000 g mol⁻¹ and a PDI of less than 2.4.

The atactic polypropylene may have a glass transition temperature (T_{g}) of −20° C. to 0° C. T_{g} may be calculated by DSC. Suitably, the atactic polypropylene has a T_{g} of −15° C. to −1° C.

The atactic polypropylene may have an optical transmissivity of >75% across the visible light region (380-750 nm). The optical transmissivity may be calculated by UV-vis spectrophotometry. Suitably the atactic polypropylene has an optical transmissivity of >80% (e.g., 80-90%) across the visible light region (380-750 nm).

It will be understood that features of the third aspect of the invention are also features of the fourth aspect of the invention.

The following numbered statements 1-67 are not claims, but instead serve to define particular aspects and embodiments of the claimed invention:

1. A process for the preparation of a polypropylene, the process comprising contacting propylene with a compound having a structure according to Formula I shown below:

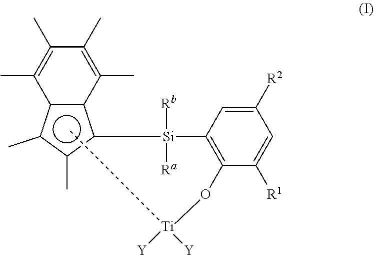

wherein

R¹ and R² are each independently selected from the group consisting of hydrogen, (1-6C)alykyl, (1-6C)haloalkyl, (1-6C)alykoxy, (2-6C)alykenyl, (2-6C)alykynyl, —NR³R⁴ and —(O)ₙ—(CR⁵R⁸)ₘ—R⁷, where n is 0 or 1, m is 0 or 1, R³ and R⁴ are independently selected from hydrogen and (1-3C)alykyl, R⁵ and R⁶ are each independently hydrogen or (1-2C)alykyl, and R⁷ is selected from the group consisting of aryl, heteroaryl, carbocyclyl and heterocyclyl, and where each R⁷ is independently optionally substituted with one or more groups R⁸ selected from the group consisting of halo, hydroxy, (1-4C)alykyl, (1-4C)haloalkyl and (1-3C)alykoxy;

R^{a} and R^{b} are each independently selected from (1-4C)alykyl, (2-4C)alykenyl and aryl;

each Y is independently selected from the group consisting of hydride, halo, (1-5C)alykyl, (1-5C)alykoxy, —(CH₂)ₚSi(R⁹)₃, —NR¹⁰R¹¹, and —(O)—(CR¹²R¹³)ᵣ—R¹⁴, where p is 1 or 2, q is 0 or 1, r is 0 or 1, each R⁹ is independently (1-3C)alykyl, R¹⁰ and R¹¹ are independently selected from hydrogen and (1-3C)alykyl, R¹² and R¹³ are independently selected from hydrogen and (1-2C)alykyl, and R¹⁴ is selected from the group consisting of aryl, heteroaryl, carbocyclyl and heterocyclyl, and where each R¹⁴ is independently optionally substituted with one or more groups R¹⁵ selected from the group consisting of halo, hydroxy, (1-4C)alykyl, (1-4C)haloalkyl and (1-3C)alykoxy.

2. The process of statement 1, wherein R¹ and R² are each independently selected from the group consisting of hydrogen, (1-5C)alykyl, (1-5C)alykoxy and —(O)ₙ—(CR⁵R⁶)ₘ—R⁷.

3. The process of statement 1 or 2, wherein R¹ and R² are each independently selected from the group consisting of hydrogen, (1-4C)alykyl and —(O)ₙ—(CR⁵R⁶)ₘ—R⁷.

4. The process of statement 1, 2 or 3, wherein R⁷ is selected from the group consisting of aryl and heteroaryl.

5. The process of any one of the preceding statements, wherein R⁷ is selected from the group consisting of phenyl and 5-6 membered heteroaryl, wherein said 5-6 membered heteroaryl contains 1 or 2 nitrogen heteroatoms.

6. The process of any one of the preceding statements, wherein R⁷ is phenyl.

7. The process of any one of the preceding statements, wherein R⁸ is selected from the group consisting of halo and (1-3C)alykyl.

8. The process of statement 1, wherein R¹ and R² are each independently selected from the group consisting of hydrogen, methyl, tert-butyl and —C(CH₃)₂Ph, where Ph denotes phenyl.

9. The process of statement 1, wherein R¹ and R² are tert-butyl.

10. The compound of any one of the preceding statements, wherein R^{a} and R^{b} are each independently selected from (1-4C)alykyl and (2-4C)alykenyl.

11. The compound of any one of statements 1 to 9, wherein R^{a} and R^{b} are each independently selected from (1-3C)alykyl and aryl (e.g. phenyl).

12. The compound of any one of the preceding statements, wherein one of R^{a} and R^{b} is methyl.

13. The process of any one of the preceding statements, wherein R^{a} and R^{b} are identical.

14. The process of any one of the preceding statements, wherein R^{a} and R^{b} are methyl.

15. The process of any one of the preceding statements, wherein each Y is independently selected from the group consisting of hydride, chloro, bromo, iodo, (1-3C)alykyl, (1-3C)alykoxy, —(CH₂)ₚSi(R⁹)₃, —NR¹⁰R¹¹, and —(O)_{q}—(CR¹²R¹³), —R¹⁴.

16. The process of any one of the preceding statements, wherein p is 1 and R⁹ is methyl.

17. The process of any one of the preceding statements, wherein R¹⁰ and R¹¹ are independently selected from (1-3C)alykyl.

18. The process of any one of the preceding statements, wherein R¹² and R¹³ are hydrogen.

19. The process of any one of the preceding statements, wherein R¹⁴ is selected from the group consisting of aryl and heteroaryl.

20. The process of any one of the preceding statements, wherein R¹⁴ is selected from the group consisting of phenyl and 5-6 membered heteroaryl, wherein said 5-6 membered heteroaryl contains 1 or 2 nitrogen heteroatoms.

21. The process of any one of the preceding statements, wherein R¹⁴ is phenyl.

22. The process of any one of the preceding statements, wherein R¹⁵ is selected from the group consisting of (1-4C)alykyl, (1-4C)haloalkyl and (1-3C)alykoxy.

23. The process of any one of the preceding statements, wherein R¹⁵ is selected from the group consisting of (1-4C)alykyl.

24. The process of any one of the preceding statements, wherein each Y is independently selected from the group consisting of chloro, bromo, iodo, methyl, —CH₂Si(CH₃)₃, —N(CH₃)₂ and —O-2,6-diisopropylphenyl.

25. The process of any one of the preceding statements, wherein each Y is independently selected from the group consisting of chloro, bromo, iodo and methyl.

26. The process of any one of the preceding statements, wherein both Y are identical.

27. The process of any one of the preceding statements, wherein Y is chloro.

28. The process of any one of the preceding statements, wherein the compound of Formula I has a structure according to Formula I-A shown below:

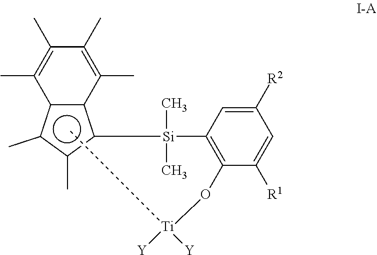

wherein R¹, R² and Y are as defined in any one of the preceding statements.

29. The process of any one of the preceding statements, wherein the compound of Formula I has a structure according to Formula I-B shown below:

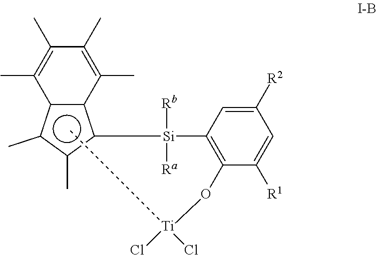

wherein R¹, R², R^{a} and R^{b} are as defined in any one of statements 1 to 27.

30. The process of any one of the preceding statements, wherein the compound of Formula I has a structure according to Formula I-C shown below:

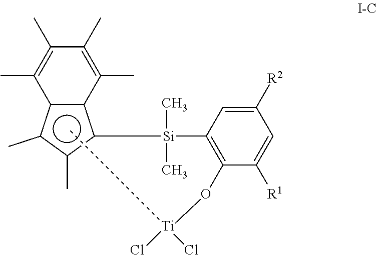

wherein R¹ and R² are as defined in any one of statements 1 to 27.

31. The process of any one of the preceding statements, wherein the compound of Formula I has a structure according to any one of the following:

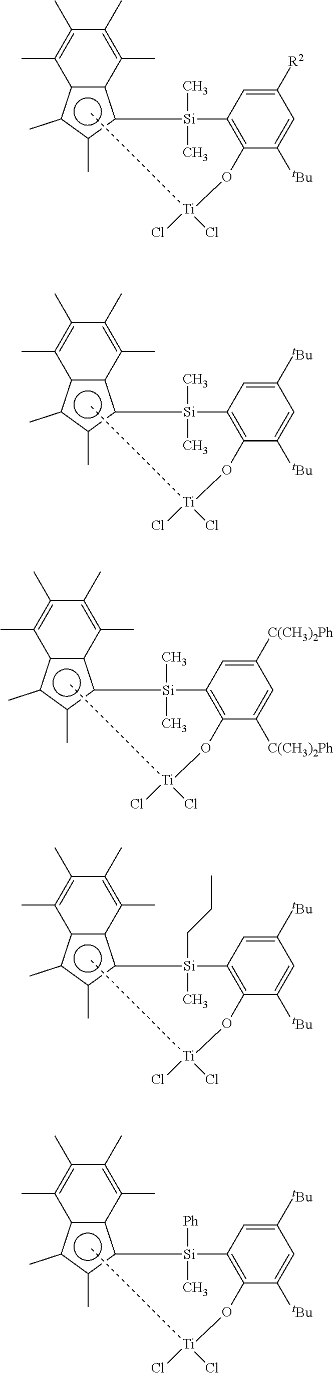

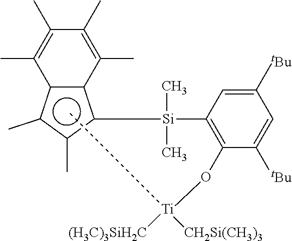

wherein ^{t}Bu denotes tert-butyl and Ph denotes phenyl.

32. The process of any one of the preceding statements, wherein the compound of Formula I is supported on a catalyst support.

33. The process of statement 32, wherein the catalyst support is selected from the group consisting of silica, layered double hydroxide, methylaluminoxane-activated silica, methylaluminoxane-activated layered double hydroxide and solid polymethylaluminoxane.

34. The process of statement 33, wherein the catalyst support is solid polymethylaluminoxane.

35. The process of any one of statements 1 to 31, wherein the compound of Formula I is unsupported and the process is conducted in solution phase.

36. The process of any one of statements 1 to 34, wherein the compound of Formula I is supported on a catalyst support and the process is conducted in slurry phase.

37. The process of any preceding statement, wherein the process is conducted in the presence of an alkyl aluminium compound.

38. The process of statement 37, wherein the alkyl aluminium compound is selected from the group consisting of triisobutylaluminium, methylaluminoxane, triethylaluminium and trimethylaluminium.

39. The process of statement 38, wherein the alkyl aluminium compound is methylaluminoxane.

40. The process of any preceding statement, wherein the process is conducted at a temperature of 5 to 90° C.

41. The process of any preceding statement, wherein the process is conducted at a temperature of 30 to 75° C.

42. The process of any preceding statement, wherein the process is conducted in a nonpolar, nonaromatic hydrocarbon solvent.

43. The process of statement 42, wherein the solvent is hexane.

44. The process of any preceding statement, wherein the polypropylene is atactic.

45. Polypropylene obtained, directly obtained or obtainable by the process of any preceding statement.

46. Atactic polypropylene having a molecular weight (M_{w}) greater than 500,000 g mol⁻¹.

47. The polypropylene of statement 45 or 46, wherein the polypropylene has a degree of crystallinity of <1% (e.g., is amorphous), when measured by DSC.

48. The polypropylene of statements 45, 46 or 47, wherein the polypropylene has no detectable melting enthalpy (ΔH_{f}) when analysed by DSC.

49. The polypropylene of any one of statements 45 to 48, wherein the polypropylene has a molecular weight (M_{w}) of greater than 600,000 g mol⁻¹.

50. The polypropylene of any one of statements 45 to 48, wherein the polypropylene has a molecular weight (M_{w}) of greater than 700,000 g mol⁻¹.

51. The polypropylene of any one of statements 45 to 48, wherein the polypropylene has a molecular weight (M_{w}) of greater than 800,000 g mol⁻¹.

52. The polypropylene of any one of statements 45 to 48, wherein the polypropylene has a molecular weight (M_{w}) of greater than 900,000 g mol⁻¹.

53. The polypropylene of any one of statements 45 to 48, wherein the polypropylene has a molecular weight (M_{w}) of greater than 1,000,000 g mol⁻¹.

54. The polypropylene of any one of statements 45 to 48, wherein the polypropylene has a molecular weight (M_{w}) of greater than 1,100,000 g mol⁻¹.

55. The polypropylene of any one of statements 45 to 48, wherein the polypropylene has a molecular weight (M_{w}) of greater than 1,200,000 g mol⁻¹.

56. The polypropylene of any one of statements 45 to 48, wherein the polypropylene has a molecular weight (M_{w}) of greater than 1,300,000 g mol⁻¹.

57. The polypropylene of any one of statements 45 to 56, wherein the polydispersity index (PDI) of the polypropylene is less than 3.0.

58. The polypropylene of any one of statements 45 to 56, wherein the polydispersity index (PDI) of the polypropylene is less than 2.8.

59. The polypropylene of any one of statements 45 to 56, wherein the polydispersity index (PDI) of the polypropylene is less than 2.6.

60. The polypropylene of any one of statements 45 to 56, wherein the polydispersity index (PDI) of the polypropylene is less than 2.4.

61. The polypropylene of any one of statements 45 to 56, wherein the polydispersity index (PDI) of the polypropylene is less than 2.2.

62. The polypropylene of any one of statements 45 to 61, wherein the polypropylene has a Pᵣ of 0.25-0.75.

63. The polypropylene of any one of statements 45 to 61, wherein the polypropylene has a Pᵣ of 0.45-0.55.

64. The polypropylene of any one of statements 45 to 63, wherein the polypropylene has a glass transition temperature (T_{g}) of −20° C. to 0° C.

65. The polypropylene of any one of statements 45 to 63, wherein the polypropylene has a glass transition temperature (T_{g}) of −15° C. to −1° C.

66. The polypropylene of any one of statements 45 to 65, wherein the polypropylene has an optical transmissivity of >75% across the visible light region (380-750 nm).

67. The polypropylene of any one of statements 45 to 65, wherein the polypropylene has an optical transmissivity of >80% across the visible light region (380-750 nm).

### EXAMPLES

One or more examples of the invention will now be described, for the purpose of illustration only, with reference to the accompanying figures, in which:

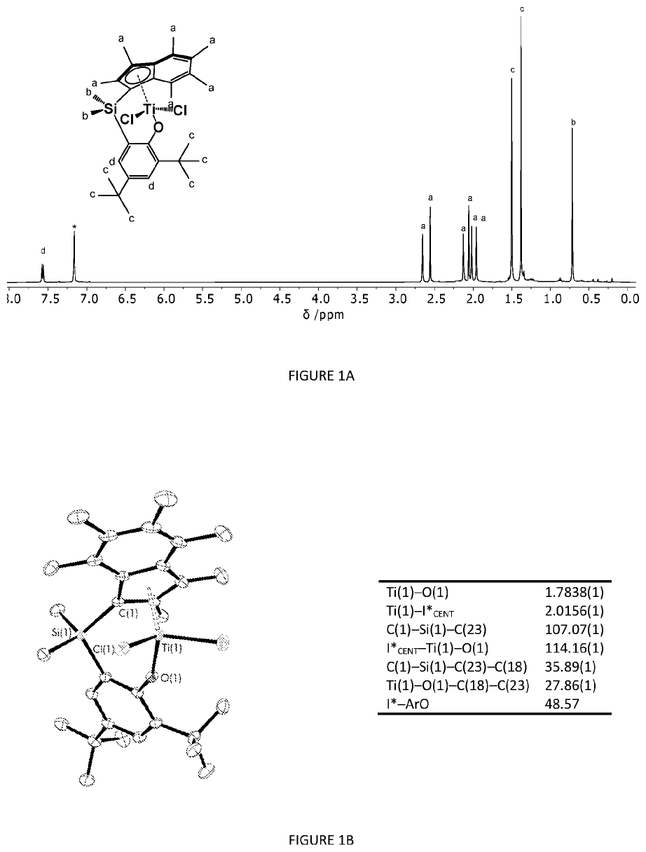

FIG. 1A shows ¹H NMR spectrum (400 MHz, benzene-d₆, 298 K) of

$${}^{{}^{Me} 2} SB ( {}^{{}^{{}^{t} Bu} 2} ArO , {I}^{*} ) {TiCl}_{2} .$$

The asterisk (*) denotes residual protio-benzene.

FIG. 1B shows solid-state structure and table of crystallographic parameters of

$${}^{{}^{Me} 2} SB ( {}^{{}^{{}^{t} Bu} 2} ArO , {I}^{*} ) {TiCl}_{2} ;$$

bond lengths in Å and angles in °, thermal displacement ellipsoids drawn at 30% probability and all hydrogen atoms omitted for clarity.

FIG. 2A shows slurry-phase propylene polymerisation activity as a function of temperature of sMAO-supported ^{Me2}SB (^{tBu,Me}ArO,I*)TiCl₂ (square), ^{Me2}SB(^{tBu2}ArO,I*)TiCl₂ (triangle), ^{Me2}SB (^{tBu2}ArO,I*)Ti(CH₂SiMe₃)₂ (open triangle), ^{Me2}SB(^{Cumyl2}ArO,I*)TiCl₂ (circle), and ^{Me2}SB (^{tBu,Me}ArO,Ind)TiCl₂ (diamond). Polymerisation conditions: [Al_{sMAO}]₀/[Ti]₀=200, [Al_{MAO}]₀/[Ti]₀=1000, propylene (2 bar), pre-catalyst (10 mg), hexanes (50 mL), and 30 minutes or until stirring ceased. Error bars shown at one standard deviation.

FIG. 2B shows slurry-phase propylene polymerisation activity as a function of temperature of sMAO-supported ^{Me2}SB(^{tBu,Me}ArO,I*)TiCl₂ (square), ^{Me2}SB(^{tBu2}ArO,I*)TiCl₂ (triangle), ^{Me2}SB (^{tBu2}ArO,I*)Ti(CH₂SiMe₃)₂ (open triangle), ^{Me2}SB(^{Cumyl2}ArO,I*)TiCl₂ (circle), ^{Me2}SB (^{tBu,Me}ArO,Ind)TiCl₂ (diamond), rac-^{Me,nPr}SB(^{tBu2}ArO,I*)TiCl² (star), and rac-^{Me,Ph}SB(^{tBu2}ArO,I*)TiCl² (open star). Polymerisation conditions: [Al^{sMAO}]₀/[Ti]₀=200, [Al^{MAO}]₀/[Ti]⁰=1000, propylene (2 bar), pre-catalyst (10 mg), hexanes (50 mL), and 30 minutes or until stirring ceased. Error bars shown at one standard deviation.

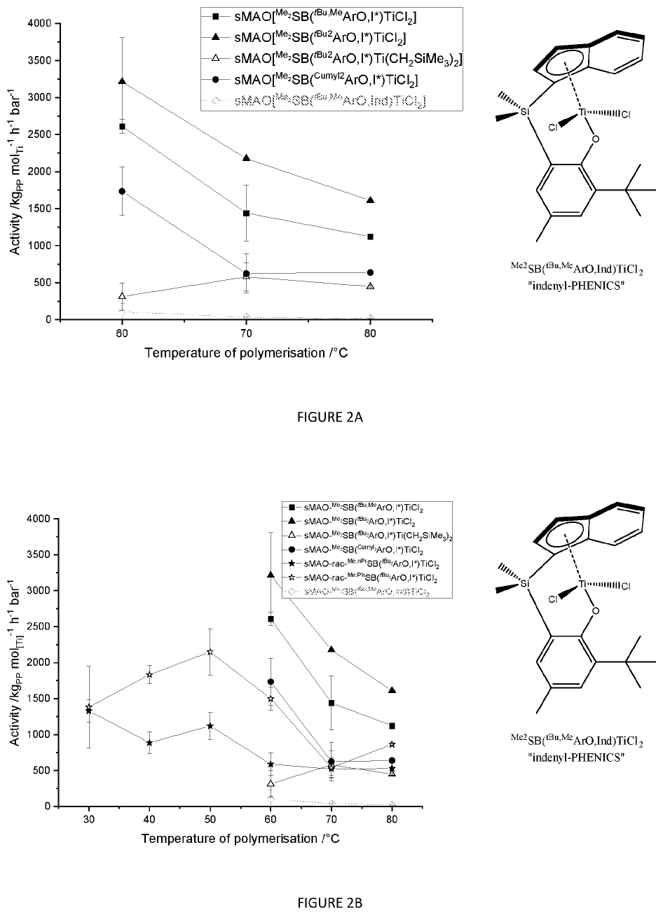

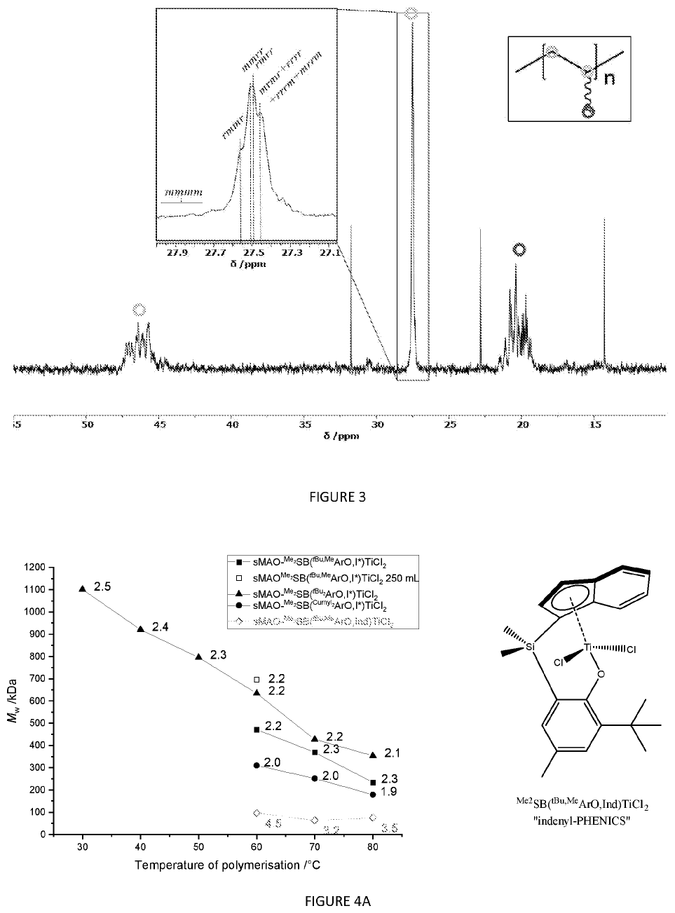

FIG. 3 shows ¹³C{¹H} NMR spectrum (101 MHz, chloroform-d, 298 K) of atactic polypropylene (aPP) synthesised at 70° C. using sMAO-^{Me2}SB (^{tBu,Me}ArO,I*)TiCl². Pentad assignments from Miyatake et al., Polym. J., 1989, 21, 809-814. Polymerisation conditions: [Al^{sMAO}]₀/[M]₀=200, [Al_{MAO}]₀/[M]₀=1000, propylene (2 bar), pre-catalyst (10 mg), hexanes (50 mL), 30 minutes, and 70° C.

FIG. 4A shows weight-average molecular weight (M_{w}) of polypropylene as a function of temperature of sMAO-supported ^{Me2}SB(^{tBu,Me}ArO,I*)TiCl₂ (square), ^{Me2}SB(^{tBu2}ArO,I*)TiCl₂ (triangle), ^{Me2}SB(^{Cumyl2}ArO,I*)TiCl₂(circle), and ^{Me2}SB(^{tBu,Me}ArO,Ind)TiCl₂ (diamond). PDIs (M_{w}/Mₙ) annotated. Polymerisation conditions: [Al_{sMAO}]₀/[Ti]₀=200, [Al_{MAO}]₀ /[Ti]₀=1000, propylene (2 bar), pre-catalyst (10 mg), hexanes (50 mL), and 30 minutes or until stirring ceased.

FIG. 4B shows weight-average molecular weight (M_{w}) of polypropylene as a function of temperature of sMAO-supported ^{Me2}SB(^{tBu,Me}ArO,I*)TiCl₂ (square), ^{Me2}SB(^{tBu2}ArO,I*)TiCl₂ (triangle), ^{Me2}SB(^{tBu2}ArO,I*)Ti(CH₂SiMe₃)₂ (open triangle), ^{Me2}SB(^{Cumyl2}ArO, I*)TiCl² (circle), ^{Me2}SB(^{tBu,Me}ArO,Ind)TiCl₂ (diamond), rac-^{Me,nPr}SB(^{tBu2}ArO,I*)TiCl₂ (star), and rac-^{Me,Ph}SB(^{tBu2}ArO,I*)TiCl₂ (open star). PDIs (M_{w}/Mₙ) annotated. Polymerisation conditions: [Al_{sMAO}]₀/[Ti]₀=200, [Al_{MAO}]₀/[Ti]₀=1000, propylene (2 bar), pre-catalyst (10 mg), hexanes (50 mL), and 30 minutes or until stirring ceased.

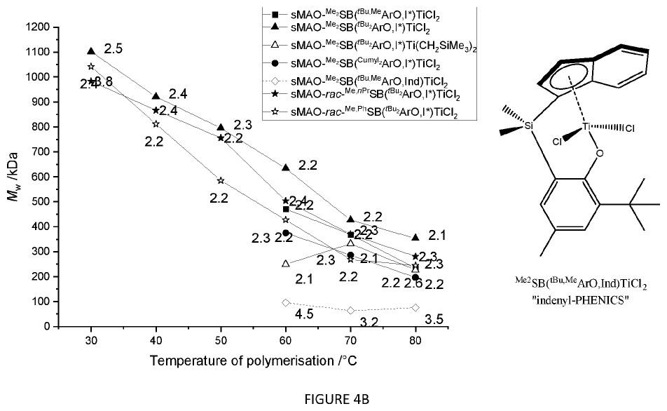

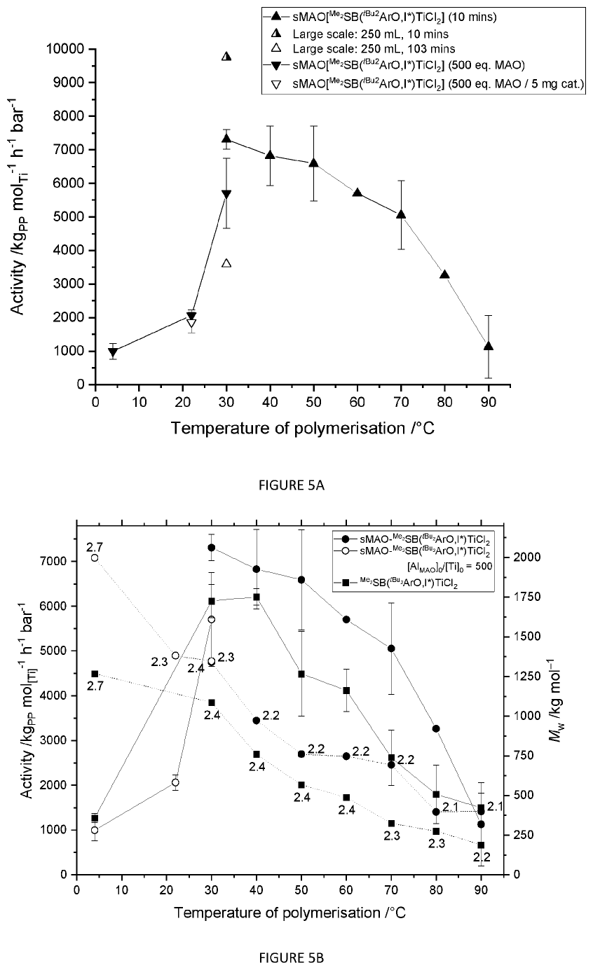

FIG. 5A shows slurry-phase propylene polymerisation activity as a function of temperature of sMAO-^{Me2}SB(^{tBu2}ArO,I*)TiCl₂. Polymerisation conditions: [Al_{sMAO}]₀/[Ti]₀=200, [Al_{MAO}]₀/[Ti]₀=1000 (upward triangle) or 500 (downward triangle), propylene (2 bar), pre-catalyst (10 mg or 5 mg), hexanes (50 mL or 250 mL), and 10 minutes or 103 minutes. Error bars shown at one standard deviation.

FIG. 5B shows slurry-phase propylene polymerisation activity and weight-average molecular weight (M_{w}) of polypropylene as a function of temperature of solution-phase and sMAO-supported ^{Me2}SB(^{tBu2}ArO,I*)TiCl₂. PDIs (M_{w}/Mₙ) annotated. Polymerisation conditions: [Al_{sMAO}]₀/[Ti]₀=200, [Al_{MAO}]₀/[Ti]₀=1000 or 500, propylene (2 bar), pre-catalyst (714 nmol_{Ti}), hexanes (50 mL), and 10 minutes. Error bars shown at one standard deviation.

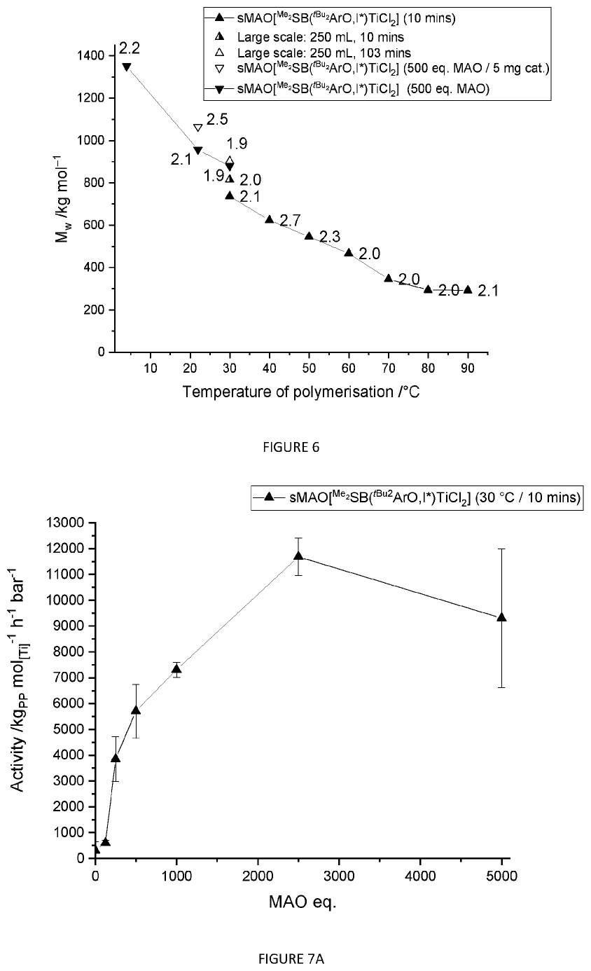

FIG. 6 shows weight-average molecular weight (M_{w}) of polypropylene as a function of temperature of sMAO-^{Me2}SB(^{tBu2}ArO,I*)TiCl₂. PDIs (M_{w}/Mₙ) annotated. Polymerisation conditions: [Al_{sMAO}]₀/[Ti]₀=200, [Al_{MAO}]₀/[Ti]₀=1000 (upward triangle) or 500 (downward triangle), propylene (2 bar), pre-catalyst (10 mg or 5 mg), hexanes (50 mL or 250 mL), and 10 minutes or 103 minutes.

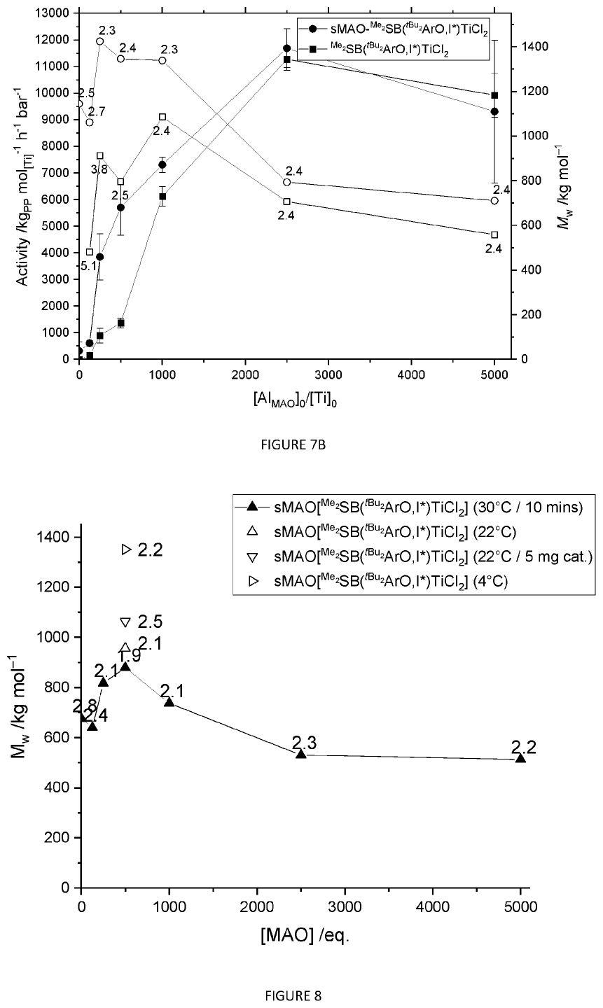

FIG. 7A shows slurry-phase propylene polymerisation activity as a funtion of [Al_{MAO}]₀/[Ti]₀ of sMAO-^{Me2}SB(^{tBu2}ArO,I*)TiCl₂. Polymerisation conditions: [Al_{sMAO}]₀/[Ti]₀=200, propylene (2 bar), pre-catalyst (10 mg or 5 mg), hexanes (50 mL), 10 minutes, and 30° C., 22° C. or 4° C. Error bars shown at one standard deviation.

FIG. 7B shows slurry-phase propylene polymerisation activity and weight-average molecular weight (M_{w}) of polypropylene as a function of [Al_{MAO}]₀/[Ti]₀, of solution-phase and sMAO-supported ^{Me2}SB(^{tBu2}ArO,I*)TiCl₂. Open squares and circles represent the respective M_{w} (kg mol⁻¹) values with PDIs (M_{w}/Mₙ) annotated. Polymerisation conditions: [Al_{sMAO}]₀/[Ti]₀=200, propylene (2 bar), pre-catalyst (714 nmol_{Ti}), hexanes (50 mL), and 10 minutes. Error bars shown at one standard deviation.

FIG. 8 shows weight-average molecular weight (M_{w}) of polypropylene as a function of [Al_{MAO}]₀/[Ti]₀ of sMAO-^{Me2}SB (^{tBu2}ArO,I*)TiCl₂. PDIs (M_{w}/Mₙ) annotated. Polymerisation conditions: [Al_{sMAO}]₀/[Ti]₀=200, propylene (2 bar), pre-catalyst (10 mg or 5 mg), hexanes (50 mL), 10 minutes, and 30° C., 22° C. or 4° C.

FIG. 9 shows slurry-phase propylene polymerisation activity and weight-average molecular weight (M_{w}) of polypropylene as a function of catalyst mass of solution-phase ^{Me2}SB(^{tBu2}ArO,I*)TiCl₂. PDIs (M_{w}/Mₙ) annotated. Polymerisation conditions: [Al_{MAO}]₀/[Ti]₀=1000, propylene (2 bar), hexanes (50 mL), and 10 minutes. Error bars shown at one standard deviation.

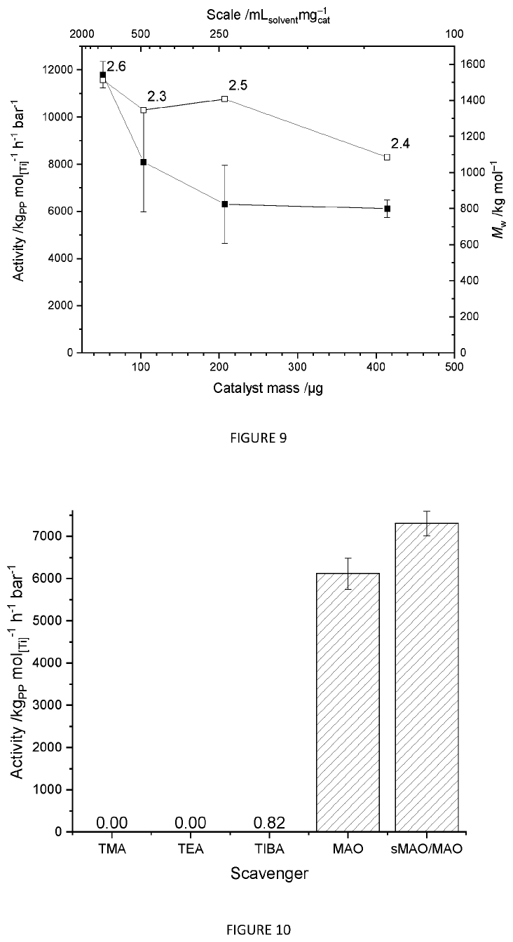

FIG. 10 shows slurry-phase propylene polymerisation activity of solution-phase and sMAO-supported ^{Me2}SB(^{tBu2}ArO,I*)TiCl₂ with varying aluminium scavenger. Polymerisation conditions: [Al_{scavenger}]₀/[Ti]₀=1000, propylene (2 bar), pre-catalyst (714 mol_{Ti}) hexanes (50 mL), and 10 minutes. Error bars shown at one standard deviation.

FIG. 11A shows differential scanning calorimetry plots (at 20 K min⁻¹, second heating and cooling shown), of PP produced by sMAO-supported ^{Me2}SB(^{tBu,Me}ArO,I*)TiCl₂, ^{Me2}SB(^{tBu2}ArO,I*)TiCl₂, ^{Me2}SB(^{Cumyl2}ArO,I*)TiCl₂, ^{Me2}SB(^{tBu,Me}ArO,Ind)TiCl₂. Polymerisation conditions: 10 mg catalyst, 2 bar propylene, 50 mL hexanes, [Al_{MAO}]₀/[Ti]₀=1000, 30 minutes, and 60° C.

FIG. 11B shows differential scanning calorimetry plots (at 10 K min⁻¹, second heating and cooling shown), of PP produced by sMAO-supported ^{Me2}SB(^{tBu,Me}ArO,I*)TiCl₂, ^{Me2}SB(^{tBu2}ArO,I*)TiCl₂, ^{Me2}SB(^{Cumyl2}ArO,I*)TiCl₂, ^{Me2}SB(^{tBu,Me}ArO,Ind)TiCl₂. Polymerisation conditions: 10 mg catalyst, 2 bar propylene, 50 mL hexanes, [Al_{MAO}]₀/[Ti]₀=1000, 30 minutes, and 60° C.

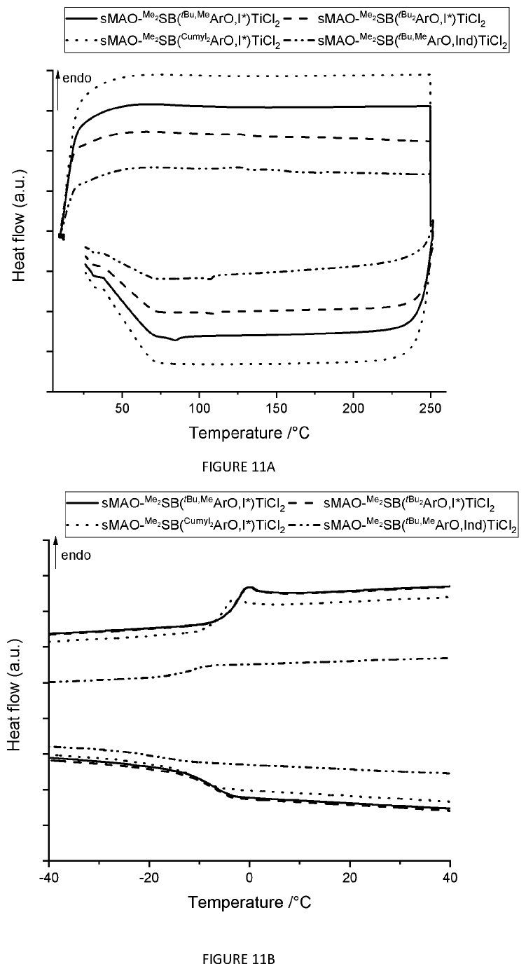

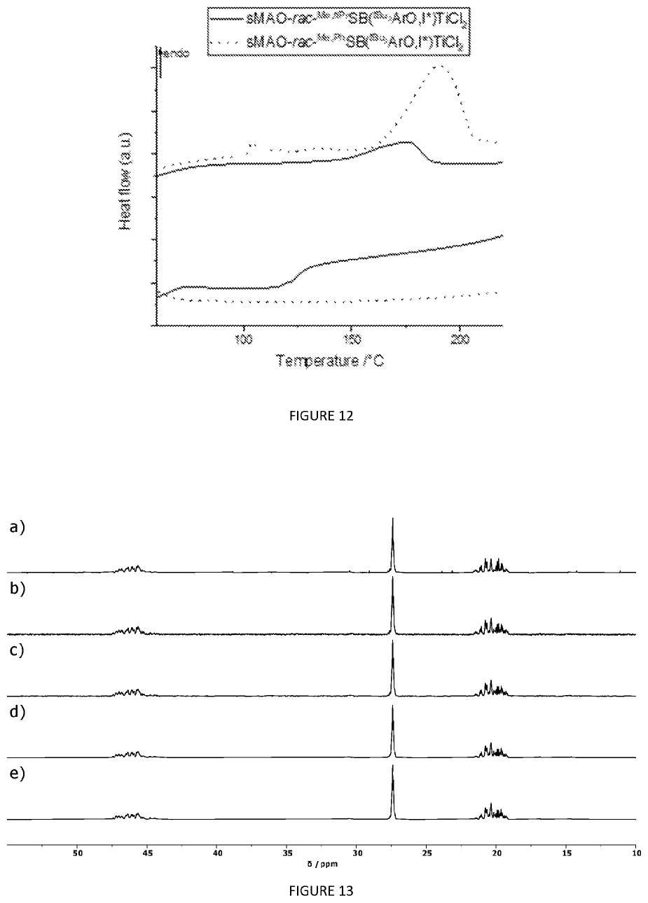

FIG. 12 shows differential scanning calorimetry plots (at 10 K min⁻¹, second heating and cooling shown), of PP produced by sMAO-supported rac-^{Me,nPr}SB(^{tBu2}ArO,I*)TiCl₂, and rac-^{Me,Ph}SB (^{tBu2}ArO,I*)TiCl₂. Polymerisation conditions: 10 mg catalyst, 2 bar propylene, 50 mL hexanes, [Al_{MAO}]₀/[Ti]₀=1000, 30 minutes, and 60° C.

FIG. 13 shows ¹³C{¹H} NMR spectra (151 MHz, chloroform-d, 298 K, 55≤δ≤10) of polypropylene synthesised by ^{Me2}SB(^{tBu2}ArO,I*)TiCl₂ at a) 4° C., b) 30° C., c) 50° C., d) 70° C., and e) 90° C. Polymerisation conditions: 414 μg catalyst, 2 bar propylene, 50 mL hexanes, [Al_{MAO}]₀/[Ti]₀=1000, and 10 minutes.

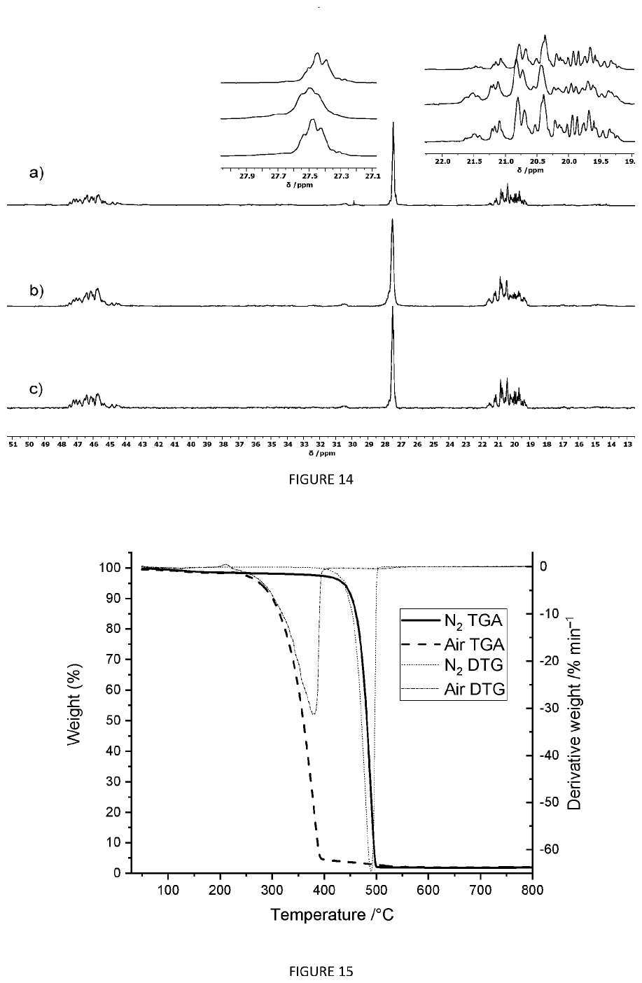

FIG. 14 shows NMR spectra (151 MHz, chloroform-d, 298 K, 55≤δ≤10) of polypropylene synthesised by a) sMAO-^{Me2}SB(^{tBu2}ArO,I*)TiCl₂, b), sMAO-rac-^{Me,Pr}SB(^{tBu2}ArO,I*)TiCl₂ and c) sMAO-rac-^{Me,Ph}SB(^{tBu2}ArO,I*)TiCl₂ at 60° C. Polymerisation conditions: 10 mg pre-catalyst, 2 bar propylene, 50 mL hexanes, [Al_{MAO}]₀/[Ti]₀=1000, and 30 minutes.

FIG. 15 shows thermogravimetric analysis of UHMWaPP prepared using ^{Me2}SB(^{tBu2}ArO,I*)TiCl₂. Polymerisation conditions: 0.714 μmol pre-catalyst, 2 bar propylene, 250 mL hexanes, [Al_{MAO}]₀/[Ti]₀=5000, 120 minutes, and 30° C.

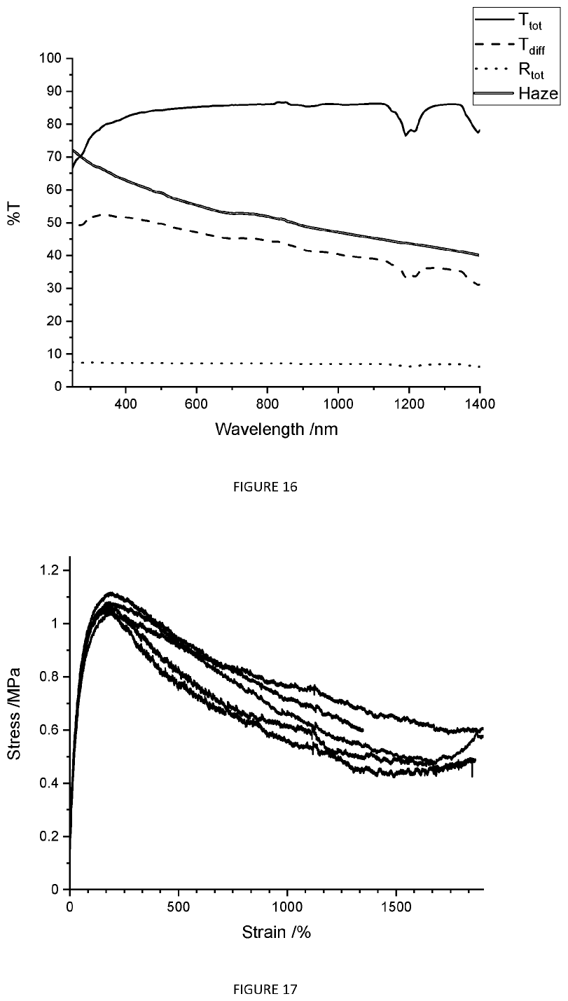

FIG. 16 shows UV-Vis-NIR spectrophotometry of UHMWaPP, prepared using ^{Me2}SB(^{tBu2}ArO,I*)TiCl₂, as a function of wavelength. Polymerisation conditions: 0.714 μmol pre-catalyst, 2 bar propylene, 250 mL hexanes, [Al_{MAO}]₀/[Ti]₀=5000, 120 minutes, and 30° C.

FIG. 17 shows engineering tensile stress-stain curves of UHMWaPP prepared using ^{Me2}SB(^{tBu2}ArO,I*)TiCl₂. Polymerisation conditions: 0.714 μmol pre-catalyst, 2 bar propylene, 250 mL hexanes, [Al_{MAO}]₀/[Ti]₀=5000, 120 minutes, and 30° C. Eₜ=2.05 MPa, σ_{M}=1.08 MPa, ε_{M}=184%, ε_{B}>1900%.

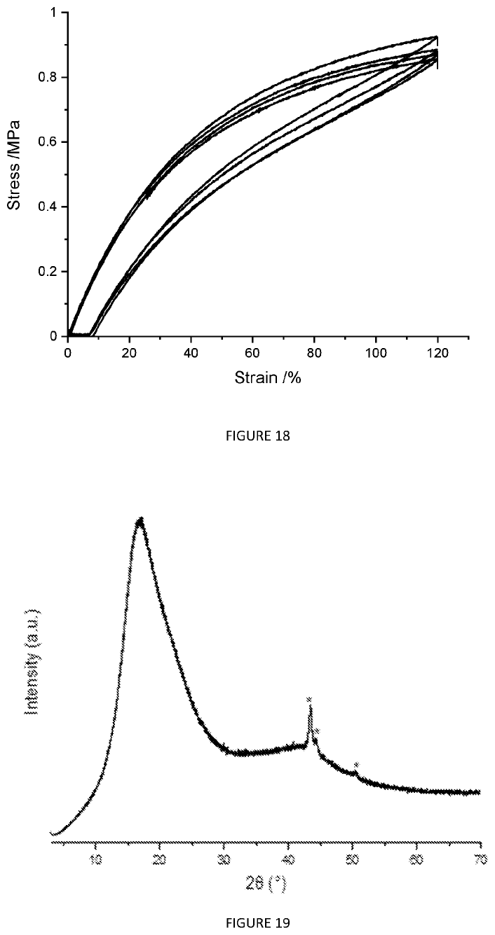

FIG. 18 shows elastic hysteresis curves of UHMWaPP prepared using ^{Me2}SB(^{tBu2}ArO,I*)TiCl₂. Polymerisation conditions: 0.714 μmol pre-catalyst, 2 bar propylene, 250 mL hexanes, [Al_{MAO}]₀/[Ti]₀=5000, 120 minutes, and 30° C. Tension set=7-8%.

FIG. 19 shows the powder X-ray diffractogram of UHMWaPP prepared using ^{Me2}SB(^{tBu2}ArO,I*)TiCl₂. Polymerisation conditions: 0.714 μmol pre-catalyst, 2 bar propylene, 250 mL hexanes, [Al_{MAO}]₀/[Ti]₀=5000, 120 minutes, and 30° C. * denotes reflections from the sample holder, and the broad peak at 15-25° indicates amorphous polymer

### Materials and Methods

Air-and moisture-sensitive compounds were manipulated under an inert atmosphere of nitrogen, using standard Schlenk line techniques¹ on a dual manifold vacuum/nitrogen line or in an MBraun Labmaster 100 glovebox.

Pentane, hexane, toluene and benzene were dried using an MBraun SPS 800 solvent purification system, stored over a potassium mirror, and degassed under partial vacuum before use. Anhydrous DCM was dried using an MBraun SPS 800 system, stored over pre-activated 3 Å molecular sieves and degassed under partial vacuum before use. Tetrahydrofuran was distilled from sodium/benzophenone, stored over pre-activated 3 Å molecular sieves and degassed under partial vacuum before use.

Deuterated solvents were dried over potassium metal (benzene-d₆ and toluene-d₈) or CaH₂ (chloroform-d, pyridine-d₅ and tetrahydrofuran-d₈) and reflux under reduced pressure, distilled under static vacuum, freeze-pump-thaw degassed three times and stored over pre-activated 3 or 4 Å molecular sieves. Chloroform-d was used as supplied for samples which were not air-and moisture-sensitive.

NMR spectra were recorded on either a Bruker Avance III HD NanoBay NMR (9.4 T, 400.2 MHz), a Bruker Avance III NMR (11.75 T, 499.9 MHz) or a Bruker Avance NMR (11.75 T, 500.3 MHz) with a ¹³C-detect cryoprobe. Spectra were recorded at 298 K unless otherwise stated and referenced internally to the residual protio solvent resonance. Chemical shifts, δ, are reported in parts per million (ppm) relative to tetramethylsilane (δ=0 ppm). Air-sensitive samples were prepared in a glovebox under an inert atmosphere of nitrogen, using dried deuterated solvents and sealed in 5 mm Young's tap NMR tubes. Solid-state NMR spectra were recorded by Dr Nicholas Rees (University of Oxford) on a Bruker Avance III HD NanoBay solid-state NMR spectrometer (9.4 T, 399.9 MHz). Samples were spun at the magic angle at spin rates of 10 KHz for ¹³C and ²⁹Si, and 20 kHz for ²⁷Al. ¹³C NMR spectra were referenced to adamantane, ²⁷Al to aluminium nitrate, and ²⁹Si to kaolinite.

Single-crystal X-ray diffraction data collection and structure determination were performed by Dr Zoë R. Turner (University of Oxford). Crystals were mounted on MiTeGen MicroMounts using perfluoropolyether oil and rapidly transferred to a goniometer head on a diffractometer fitted with an Oxford Cryosystems Cryostream open-flow nitrogen cooling device.² Data collections were carried out at 150 K on an Oxford Diffraction Supernova diffractometer using mirror-monochromated Cu Kα radiation (λ=1.54178 Å) and data were processed using CryAlisPro.³ The structures were solved using direct methods (SIR-92)⁴ or a charge flipping algorithm (SUPERFLIP)⁵ and refined by full-matrix least-squares using the Win-GX software suite.⁶ Molecular bond lengths and angles were calculated, where required, using PLATON.⁷ Illustrations of the solid state molecular structures were created using ORTEP.⁸ Thermal ellipsoids were shown at 30% probability.

Gel permeation chromatography (GPC) was performed by Ms Liv Thobru and Ms Sara Herum (Norner AS, Norway) on a high temperature gel permeation chromatograph with an IR5 infrared detector (GPC-IR5). Samples were prepared by dissolution in 1,2,4-trichlorobenzene (TCB) containing 300 ppm of 3,5-di-tert-buty-4-hydroxytoluene (BHT) at 160° C. for 90 minutes and then filtered with a 10 μm SS filter before being passed through the GPC column. The samples were run under a flow rate of 0.5 mL min⁻¹ using TCB containing 300 ppm of BHT as mobile phase with 1 mg mL⁻¹ BHT added as a flow rate marker. The GPC column and detector temperature were set at 145 and 160° C. respectively.

Differential scanning calorimetry was performed on a Mettler Toledo TGA/DSC 1 System within a temperature range of 25-180° C. at a rate of 10 K min⁻¹. Polymer samples were sealed in 100 μL aluminium crucibles. An empty crucible was used as a reference, and the DSC was calibrated using indium.

2,3,4,5,6,7-hexamethylindene (SCG Chemicals Co., Ltd.), ⁿBuLi (1.6 M in hexanes, Sigma Aldrich), 4-methyl-2-tert-butylphenol (Sigma Aldrich), 6-bromo-2,4-di-tert-butylphenol (Alfa Aesar), and bromine (Sigma Aldrich) were all used as received. TiCl₄.2THF was prepared according to a literature procedure.⁹ Et₃N was dried over KOH, distilled under static vacuum and freeze-pump-thaw degassed before use. 2,4-bis(α,α-dimethylbenzyl)phenol (Sigma Aldrich) was recrystallized from hot ethanol before use. Me₂SiCl₂ (Sigma Aldrich) was dried over pre-activated 3 Å molecular sieves before use. Allyl bromide was washed with NaHCO₃ followed by distilled water and dried over MgSO₄. Propylene was supplied by CK Special Gases Ltd. and used as received. Solid polymethylaluminoxane (sMAO) was supplied by SCG Chemicals Co., Ltd. (Thailand) as a slurry in toluene which was dried under vacuum before use. MAO was supplied by Chemtura Corporation as a slurry in toluene which was dried under vacuum before use.

### Synthesis of PHEN-I* Compounds

Synthesis of ^{Me(R1)}SB(^{R,R′}ArO,I*)MCl₂, (R¹=Me, ⁿPr, Ph. R, R′=^{t}Bu, Me; ^{t}Bu, ^{t}Bu; cumyl, cumyl. M=Ti, Zr.)

Having regard to Scheme 1 below, electrophilic ortho bromination of the starting phenol was achieved quantitatively in a stoichiometric reaction in DCM stirred for 90 minutes. Allyl protection was carried out by the dropwise addition of a solution of bromodialkylphenol and 1.5 equivalents of allyl bromide to a 10% aqueous solution of 1.5 equivalents NaOH. The protected bromophenols were treated with 1.3 equivalents of ⁿBuLi at −78° C. and then 3 equivalents of Me(R¹)SiCl₂ to afford the desired chlorosilyl intermediates in good yields (57-83%). Stirring these intermediates with Ind^{#}Li in THF overnight afforded the allyl-protected proligands in a 75% yield on multigram scales. The proligands were treated with ⁿBuLi in the presence of triethylamine, followed by the addition of MCl₄.2THF. Following work-up, the resulting brick-red solid products were washed with pentane to afford titanium dichloro complexes, ^{Me(R1)}SB(^{R,R′}ArO,I*)MCl₂, in yields of 19-30%.

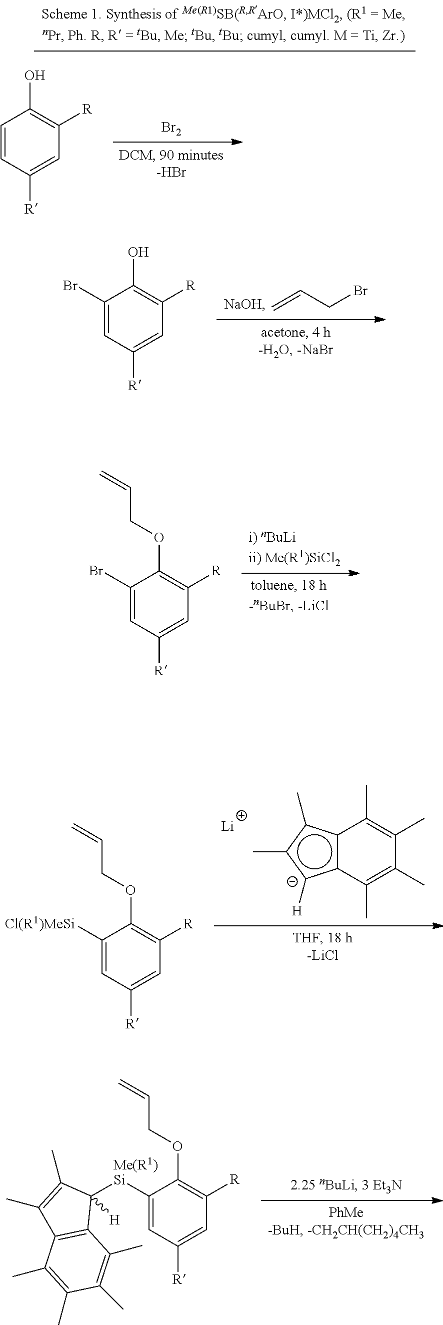

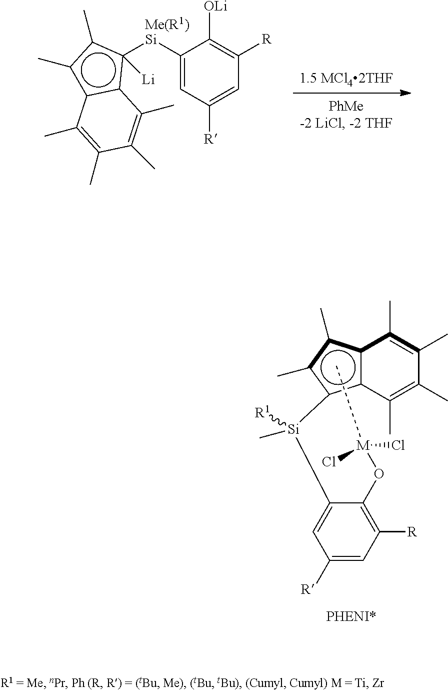

The ¹H NMR spectra of

$${}^{{}^{Me} 2} SB ( {}^{{}^{{}^{t} Bu} 2} ArO , {I}^{*} ) {TiCl}_{2}$$

(FIG. 1A) displays the diagnostic resonances of PHENI* complexes. The spectrum contains six I*-Me singlets between 2.66 and 1.96 ppm, ^{t}Bu singlets between 1.50 and 1.38 ppm, dimethylsilyl singlets between 0.72 and 0.66 ppm and an aromatic pair of doublets between 7.58 and 7.19 ppm for the meta aryl protons with a ⁴J_{H—H} constant of 2 Hz. The solid-state structure and table of crystallographic parameters of

$${}^{{}^{Me} 2} SB ( {}^{{}^{{}^{t} Bu} 2} ArO , {I}^{*} ) {TiCl}_{2}$$

are shown in FIG. 1B. Spectral assignments

$${}^{{}^{Me} 2} SB ( {}^{{}^{{}^{t} Bu} 2} ArO , {I}^{*} ) {TiCl}_{2}$$

and other selected ^{Me(R1)}SB(^{R,R′}ArO,I*)MCl₂ compounds are outlined below.

$${}^{{}^{Me} 2} SB ( {}^{{}^{{}^{t} Bu} 2} ArO , {I}^{*} ) {TiCl}_{2}$$

¹H NMR (400 MHz, benzene-d₆, 298 K): δ 7.58 (d, ⁴J_{H—H}=2.4 Hz, 1H, 3,5-C₆H₂), 7.56 (d, ⁴J_{H—H}=2.4 Hz, 1H, 3,5-C₆H₂), 2.65 (s, 3H, I*Me), 2.55 (s, 3H, I*Me), 2.12 (s, 3H, I*Me), 2.05 (s, 3H, I*Me), 2.02 (s, 3H, I*Me), 1.96 (s, 3H, I*Me), 1.50 (s, 9H, CMe₃), 1.38 (s, 9H, CMe₃), and 0.72 (s, 6H, SiMe) ppm.
¹³C {¹H} NMR (126 MHz, benzene-d₆, 298 K): δ 167.32 (1-C₆H₂), 146.91 (2,4-C₆H₂), 144.39 (I*), 137.60 (I*), 136.61 (I*), 136.15 (I*), 136.10 (2,4-C₆H₂), 133.14 (6-C₆H₂), 132.24 (I*), 131.61 (I*), 130.85 (I*), 130.62 (I*), 127.07 (3,5-C₆H₂), 124.87 (3,5-C₆H₂), 110.40 (I*Si), 35.11 (CMe₃), 34.61 (CMe₃), 31.44 (CMe₃), 29.73 (CMe₃), 21.37 17.11 16.88 16.29 16.12 15.47 (I*Me), 3.35 and 1.44 (SiMe) ppm.

$${}^{{}^{Me} 2} SB ( {}^{{}^{t} Bu , Me} ArO , {I}^{*} ) {TiCl}_{2}$$

¹H NMR (400 MHz, benzene-d₆, 298 K): δ 7.22 (d, ⁴J_{H—H}=1.9 Hz, 1H, 3,5-C₆H₂), 7.19 (d, ⁴J_{H—H}=2.0 Hz, 1H, 3,5-C₆H₂), 2.66 (s, 3H, I*Me), 2.56 (s, 3H, I*Me), 2.27 (s, 3H, 4-C₆H₂Me), 2.14 (s, 3H, I*Me), 2.03 (s, 3H, I*Me), 2.02 (s, 3H, I*Me), 1.98 (s, 3H, I*Me), 1.46 (s, 9H, CMe₃), 0.68 (s, 3H, SiMe), and 0.66 (s, 3H, SiMe) ppm.

¹³C{¹H} NMR (126 MHz, benzene-d₆, 298 K): δ 167.79 (1-C₆H₂), 144.68 (I*), 138.03 (I*), 136.99 (2-C₆H₂), 136.95 (I*), 136.51 (I*), 134.04 (6-C₆H₂), 133.98 (4-C₆H₂), 132.50 (I*), 131.98 (I*), 131.37 (3,5-C₆H₂), 131.22 (I*), 131.01 (I*), 129.04 (3,5-C₆H₂), 110.75 (I*Si), 35.12 (CMe₃), 30.05 (CMe₃), 21.81 (I*Me), 21.44 (4-C₆H₂Me), 17.46 17.26 16.66 16.50 15.69 (I*Me), 3.62 and 1.49 (SiMe) ppm.

$${}^{{}^{Me} 2} SB ( {}^{{}^{Cumyl} 2} ArO , {I}^{*} ) {TiCl}_{2}$$

¹H NMR (400 MHz, benzene-d₆, 298 K): δ 7.51 (d, ⁴J_{H—H}=2.4 Hz, 1H, 3,5-C₆H₂), 7.46 (d, ⁴J_{H—H}=2.4 Hz, 1H, 3,5-C₆H₂), 7.37-7.17 (m, 8H, CMe₂Ph), 7.13-7.07 (m, 1H, CMe₂Ph), 7.06-7.00 (m, 1H, CMe₂Ph), 2.62 (s, 3H, I*Me), 2.42 (s, 3H, I*Me), 2.09 (s, 3H, I*Me), 2.00 (s, 3H, I*Me), 1.98 (s, 3H, I*Me), 1.90 (s, 3H, I*Me), 1.73 (s, 6H, CMe₂Ph), 1.70 (s, 3H, CMe₂Ph), 1.67 (s, 3H, CMe₂Ph), 0.60 (s, 3H, SiMe), and 0.59 (s, 3H, SiMe) ppm.

¹³C{¹H} NMR (126 MHz, benzene-d₆, 298 K): δ 166.74 (Ar), 151.09 (Ar), 169.81 (Ar), 146.72 (Ar), 144.62 (Ar), 137.54 (Ar), 136.74 (Ar), 136.51 (Ar), 136.28 (Ar), 133.84 (6-C₆H₂), 132.43 (Ar), 131.65 (Ar), 130.97 (Ar), 130.74 (Ar), 129.83 (3,5-C₆H₂), 128.46 (CMe₂Ph), 128.35 (CMe₂Ph), 128.32 (CMe₂Ph), 128.16 (CMe₂Ph), 127.97 (CMe₂Ph), 127.68 (3,5-C₆H₂), 127.13 (CMe₂Ph), 126.39 (CMe₂Ph), 126.19 (CMe₂Ph), 125.58 (CMe₂Ph), 110.69 (I*Si), 43.34, and 42.92 (CMe₂Ph), 31.26 31.23 30.60 29.00 (CMe₂Ph), 21.65 17.44 17.31 16.65 16.39 15.66 (I*Me), 3.93 1.41 (SiMe) ppm. An additional aromatic resonance was expected by not observed.

### Synthesis of

$${}^{{}^{Me} 2} SB ( {}^{R , {R}^{′}} ArO , {I}^{*} ) {TiR}_{2}^{”}$$

(R″=Br, I, OEt, NMe₂, Me, CH₂SiMe₃, O^{iPr2}Ar)

Having regard to Scheme 2 below, the ancillary chloride ligands were replaced by various other ligands, including halide, alkyl, alkoxide, aryloxide, and amide groups in quantitative yields in stoichiometric reactions performed in benzene or benzene-d₆. The halide complexes were synthesised using bromotrimethylsilane and iodotrimethylsilane respectively, with the remaining complexes synthesised using the relevant alkali metal salts.

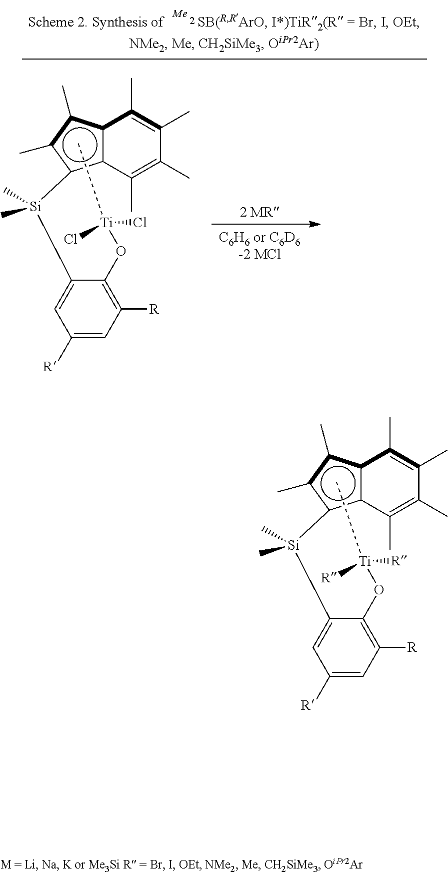

### Synthesis of Supported PHEN-I* Compounds

$$\\ sMAO ‐ {}^{{Me}_{2}} SB ( {}^{R , {R}^{{}_{} ′}} ArO , {I}^{{}_{} *} ) {TiR}_{2}^{{}_{} ″}$$

sMAO (40.2 wt % Al, 250 mg, 3.72 mmol [Al]) was combined with 0.005 equivalents of PHEN-I* compound (0.0186 mmol [Ti]) and the physical mixture homogenised thoroughly. Toluene (50 mL) was then added and the mixture was heated to 60° C. with frequent swirling for one hour, or until the solution had become colourless. After settling, the toluene supernatant was decanted, the solid product was dried under vacuum at 23° C. for 2 hours and recovered in 75-90% yields.

$$\\ SSMAO ‐ {}^{{Me}_{2}} SB ( {}^{R , {R}^{{}_{} ′}} ArO , {I}^{{}_{} *} ) {TiR}_{2}^{{}_{} ″}$$

Silica supported MAO (SSMAO) was synthesised by treating silica (PQ-ES70X, calcined at 600° C. for 6 hours) with 40 wt % dMAO. SSMAO was combined with 0.005 equivalents of PHEN-I* compound and the physical mixture homogenised thoroughly. Toluene (50 mL) was then added and the mixture was heated to 60° C. with frequent swirling for one hour, or until the solution had become colourless. After settling, the toluene supernatant was decanted, the solid product was dried under vacuum at 23° C. for 2 hours.

Mg₃Al—CO₃-1H/MAO-

$$\\ {}^{{Me}_{2}} SB ( {}^{R , {R}^{{}_{} ′}} ArO , {I}^{{}_{} *} ) {TiR}_{2}^{{}_{} ″}$$

Layered double hydroxide-supported MAO (LDHMAO) was synthesised from a 1-hexanol-washed magnesium-aluminium LDH, Mg₃Al—CO₃-1H (calcined at 150° C. for 6 hours) treated with 40 wt % dMAO. LDHMAO was combined with 0.005 equivalents of PHEN-I* compound and the physical mixture homogenised thoroughly. Toluene (50 mL) was then added and the mixture was heated to 60° C. with frequent swirling for one hour, or until the solution had become colourless. After settling, the toluene supernatant was decanted, the solid product was dried under vacuum at 23° C. for 2 hours.

### Propylene Polymerisation Studies

Slurry-phase propylene homopolymerisation was carried out using sMAO-supported PHEN-I* complexes.

Having regard to FIGS. 2A and 2B, all three of the

$$\\ sMAO ‐ {}^{{Me}_{2}} SB ( {}^{R , {R}^{{}_{} ′}} ArO , {I}^{{}_{} *} ) {TiCl}_{2}$$

complexes were active in the polymerisation or propylene, with

$$\\ sMAO ‐ {}^{{Me}_{2}} SB ( {}^{{}^{t} Bu 2} ArO , {I}^{{}_{} *} ) {TiCl}_{2}$$

being the most active. A dramatic 25-fold increase in activty is seen when

$$\\ {}^{{Me}_{2}} SB ( {}^{{}^{t} Bu , Me} ArO , {I}^{{}_{} *} ) {TiCl}_{2}$$

is compared to the comparator sMAO-supported indenyl-PHENICS complex, sMAO-

$$\\ \\ {}^{{Me}_{2}} SB ( {}^{{}^{t} Bu , Me} ArO , Ind ) {TiCl}_{2} .$$

With the bis-tert-butyl complex at 60° C. in standard 50 mL ampoules, the viscosity of the polymer solution was such that by 21 minutes stirring had ceased, and the polymerisation run was stopped. It was repeated in a larger ampoule with the same amount of catalyst, but 250 mL hexanes and a corresponding 5-fold increase in the amount of MAO, to keep the concentration constant. This run was continued for 30 minutes with stirring well maintained throughout and did not show a significantly different activity. Polymerisations were attempted with

$$\\ sMAO ‐ {}^{{Me}_{2}} SB ( {}^{{{}^{t} Bu}_{2}} ArO , {I}^{{}_{} *} ) {TiCl}_{2}$$

at 30-50° C., with the stirring becoming impeded after progressively shorted reaction times (8 m 40 s at 30° C.) indicating the further increasing in activity at lower temperatures, calculated as 6588 kg_{PP} mol_{Ti}⁻¹ h⁻¹ bar⁻¹ at 30° C. However, the results of polymerisation activities became obfuscated by the co-dependent variation of activity with reaction time and so are omitted from FIGS. 2A and 2B for clarity.

The resulting polypropylene was determined to be atactic by solution-phase ¹³C{¹H} NMR spectroscopy (see FIG. 3). GPC analysis of the resulting polymer classifies the polymer as high molecular weight atactic polypropylene (HMWaPP). Having regard to FIGS. 4A and 4B, the M_{w} of aPP formed using

$$\\ {}^{{Me}_{2}} SB ( {}^{{{}^{t} Bu}_{2}} ArO , {I}^{{}_{} *} ) {TiCl}_{2}$$

is consistently higher than

$$\\ {}^{{Me}_{2}} SB ( {}^{{}^{t} Bu , Me} ArO , {I}^{{}_{} *} ) {TiCl}_{2}$$

and

$$\\ {}^{{Me}_{2}} SB ( {}^{{Cumyl}_{2}} ArO , {I}^{{}_{} *} ) {TiCl}_{2}$$

and in all cases decreases with increasing reaction temperature. Although the activity of

$$\\ {}^{{Me}_{2}} SB ( {}^{{}^{t} Bu , Me} ArO , {I}^{{}_{} *} ) {TiCl}_{2}$$

did not change appreciably in the larger scale run with 250 mL diluent, there was a significant increase of 48% in molecular weight observed to 696 kDa, due to the decrease in the monomer mass-transport diffusion barrier resulting from more efficient stirring. This is a greater than sevenfold increase compared to the comparator sMAO-supported indenyl-PHENICS complex, sMAO-

$$\\ {}^{{Me}_{2}} SB ( {}^{{}^{t} Bu , Me} ArO , Ind ) {TiCl}_{2}$$

at the same polymerisation temperature. The molecular weight distributions are narrow, with polydispersity indices of 1.9-2.3 indicative of controlled single-site catalysis, close to the value of 2 for the Florey-distributed polymer of an idealised single-site catalyst. Despite the shorter reaction time of only 8:40 minutes, the molecular weight of aPP produced by

$$\\ {}^{{Me}_{2}} SB ( {}^{{tBu}_{2}} ArO , {I}^{{}_{} *} ) {TiCl}_{2}$$

at 30° C. is 1.10 MDa, classifying the polymer as Ultra-High Molecular Weight Atactic Polypropylene (UHMWaPP, M_{w}>1 MDa).

Polymerisation condition optimisation was performed with sMAO-

$$\\ {}^{{Me}_{2}} SB ( {}^{{tBu}_{2}} ArO , {I}^{{}_{} *} ) {TiCl}_{2} ,$$

studying the effects of temperature, MAO loading, and scale (see FIGS. 5-10). The polymerisations were run for 10 minutes to ensure efficient stirring throughout. A steady increase in activity was observed as the reaction temperature was lowered from 90° C. to 30° C., although the activity did fall as the temperature was lowered further. Activity was found to increase with an increased loading of MAO, though at the expense of M_{w}, which was highest at [Al_{MAO}]₀/[Ti]₀=500. Activity increased significantly when performed on a larger scale, to 9761 kg_{PP} mol_{Ti}⁻¹ h⁻¹ bar⁻¹ at 30° C. with 250 mL solvent. As with ethylene polymerisation, M_{w} was found to increase with decreasing reaction temperature, up to 1.351 MDa at 4° C.

No melting point was observed for amorphous UHMWaPP, with T_{g} being between −12 and −3° C. with ΔC_{p,Tg} values in the region 0.4-0.6 J° C⁻¹ g⁻¹ (See FIGS. 11A-B). Slight melting endotherms were observed in the PP synthesised by the racemic mixed-bridge complexes, at approximately 160-190° C. with crystallinities of 2-13% (see FIG. 12).

The physical properties of the UHMWaPP synthesised by PHENI* catalysts were studied by a variety of methods. TGA shows a single mass-loss event at approximately 490° C. in N₂ and 380° C. in a synthetic air mixture (see FIG. 15).

Optical transmissivity was found to be 82-89% across the visible light region (380-750 nm). Optical haze (T_{diff}/Tₜₒₜ) is calculated to be 46-67%, and total reflection measured at 7-8%, both quantities decreasing at longer wavelengths of incident light. This is indicative that UHMWPE has high optical transparency and clarity (see FIG. 16)

The density of the UHMWaPP was measured according to ISO 1183, and was found to be 876 kg m⁻³.

While specific embodiments of the invention have been described herein for the purpose of reference and illustration, various modifications and variants will be apparent to a person skilled in the art without departing from the scope of the invention.

### REFERENCES

1 D. F. Shriver and M. A. Drezdon, The Manipulation of Air-Sensitive Compounds, 2 edn., Wiley, 1986.
2 J. Cosier and A. M. Glazer, J. Appl. Crystallogr., 1986, 19, 105-107.
3 U. K. L. Oxford Diffraction Agilent Technologies, Yarnton, England.
4 A. Altomare, G. Cascarano, C. Giacovazzo, A. Guagliardi, J. Appl. Crystallogr., 1993, 26, 343-350.
5 L. Palatinus and G. Chapuis, J. Appl. Crystallogr., 2007, 40, 786-790.
6 L. Farrugia, J. Appl. Crystallogr., 1999, 32, 837-838.
7 A. L. Spek, J. Appl. Crystallogr., 2003, 36, 7-13.
8 L. J. Farrugia, J. Appl. Crystallogr., 2012, 45, 849-854.
9 C. Görl, E. Betthausen, H. G. Alt, Polyhedron, 2016, 118, 37-51.

1. A process for the preparation of a polypropylene, the process comprising contacting propylene with a compound having a structure according to Formula I shown below: 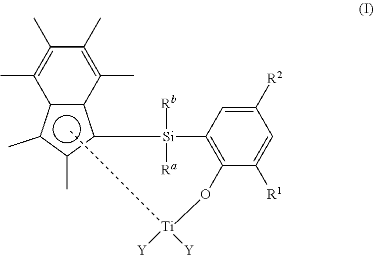
wherein
R¹ and R² are each independently selected from the group consisting of hydrogen, (1-6C)alykyl, (1-6C)haloalkyl, (1-6C)alykoxy, (2-6C)alykenyl, (2-6C)alykynyl, —NR³R⁴ and —(O)ⁿ—(CR⁵R⁶)ₘ—R⁷, where n is 0 or 1, m is 0 or 1, R³ and R⁴ are independently selected from hydrogen and (1-3C)alykyl, R⁵ and R⁶ are each independently hydrogen or (1-2C)alykyl, and R⁷ is selected from the group consisting of aryl, heteroaryl, carbocyclyl and heterocyclyl, and where each R⁷ is independently optionally substituted with one or more groups R⁸ selected from the group consisting of halo, hydroxy, (1-4C)alykyl, (1-4C)haloalkyl and (1-3C)alykoxy;
R^{a} and R^{b} are each independently selected from (1-4C)alykyl, (2-4C)alykenyl and aryl;
each Y is independently selected from the group consisting of hydride, halo, (1-5C)alykyl, (1-5C)alykoxy, —(CH₂)ₚSi(R⁹)₃, —NR¹⁰R¹¹, and —(O)_{q}—(CR¹²R¹³), —R¹⁴, where p is 1 or 2, q is 0 or 1, r is 0 or 1, each R⁹ is independently (1-3C)alykyl, R¹⁰ and R¹¹ are independently selected from hydrogen and (1-3C)alykyl, R¹² and R¹³ are independently selected from hydrogen and (1-2C)alykyl, and R¹⁴ is selected from the group consisting of aryl, heteroaryl, carbocyclyl and heterocyclyl, and where each R¹⁴ is independently optionally substituted with one or more groups R¹⁵ selected from the group consisting of halo, hydroxy, (1-4C)alykyl, (1-4C)haloalkyl and (1-3C)alykoxy.

2. The process of claim 1, wherein R¹ and R² are each independently selected from the group consisting of hydrogen, (1-5C)alykyl, (1-5C)alykoxy and —(O)ⁿ—(CR⁵R⁶)ₘ—R⁷.

3. The process of claim 1 or 2, wherein R⁷ is selected from the group consisting of phenyl and 5-6 membered heteroaryl, wherein said 5-6 membered heteroaryl contains 1 or 2 nitrogen heteroatoms.

4. The process of claim 1, 2 or 3, wherein R⁷ is phenyl.

5. The process of any one of the preceding claims, wherein R⁸ is selected from the group consisting of halo and (1-3C)alykyl.

6. The process of claim 1, wherein R¹ and R² are each independently selected from the group consisting of hydrogen, methyl, tert-butyl and —C(CH³)²Ph, where Ph denotes phenyl.

7. The process of any one of the preceding claims, wherein R^{a} and R^{b} are methyl.

8. The process of any one of the preceding claims, wherein each Y is independently selected from the group consisting of hydride, chloro, bromo, iodo, (1-3C)alykyl, (1-3C)alykoxy, —(CH₂)ₚSi(R⁹)₃, —NR¹⁰R¹¹, and —(O)^{q}—(CR¹²R¹³), —R¹⁴.

9. The process of any one of the preceding claims, wherein p is 1 and R⁹ is methyl, R¹⁰ and R¹¹ are independently selected from (1-3C)alykyl, and R¹² and R¹³ are hydrogen.

10. The process of any one of the preceding claims, wherein R¹⁴ is selected from the group consisting of phenyl and 5-6 membered heteroaryl, wherein said 5-6 membered heteroaryl contains 1 or 2 nitrogen heteroatoms.

11. The process of any one of the preceding claims, wherein R¹⁵ is selected from the group consisting of (1-4C)alykyl.

12. The process of any one of the preceding claims, wherein each Y is independently selected from the group consisting of chloro, bromo, iodo, methyl, —CH²Si(CH³)³, —N(CH³)² and —O-2,6-diisopropylphenyl.

13. The process of any one of the preceding claims, wherein Y is chloro.

14. The process of any one of the preceding claims, wherein the compound of Formula I has a structure according to Formula I-A shown below: 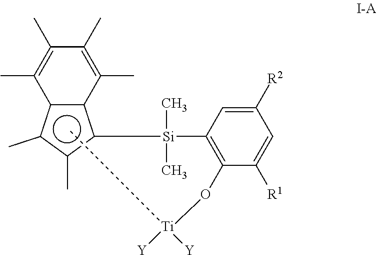
wherein R¹, R² and Y are as defined in any one of the preceding claims.

15. The process of any one of the preceding claims, wherein the compound of Formula I has a structure according to Formula I-B shown below: 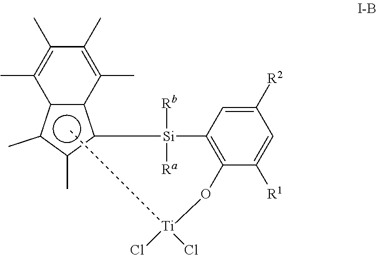
wherein R¹, R², R^{a} and R^{b} are as defined in any one of claims 1 to 24.

16. The process of any one of the preceding claims, wherein the compound of Formula I has a structure according to Formula I-C shown below: 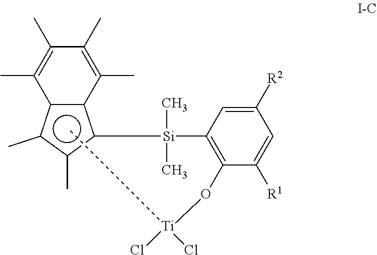
wherein R¹ and R² are as defined in any one of claims 1 to 24.

17. The process of any one of the preceding claims, wherein the compound of Formula I is supported on a supporting substrate, wherein the supporting substrate is solid polymethylaluminoxane.

18. Atactic polypropylene having a molecular weight (M_{w}) greater than 500,000 g mol⁻¹.

19. The polypropylene of claim 18, wherein the polypropylene has a degree of crystallinity of <1% (e.g., is amorphous) when analysed by DSC and/or has no detectable melting enthalpy (ΔH_{f}) when analysed by DSC.

20. The polypropylene of claim 18, wherein the polypropylene has a molecular weight (M_{w}) of greater than 700,000 g mol⁻¹, or greater than 900,000 g mol⁻¹.

21. The polypropylene of claim 18, wherein the polypropylene has a molecular weight (M_{w}) of greater than 1,100,000 g mol⁻¹.

22. The polypropylene of any one of claims 18 to 21, wherein the polydispersity index (PDI) of the polypropylene is less than 3.0.

23. The polypropylene of any one of claims 18 to 21, wherein the polydispersity index (PDI) of the polypropylene is less than 2.6.

24. The polypropylene of any one of claims 18 to 21, wherein the polydispersity index (PDI) of the polypropylene is less than 2.2.

25. The polypropylene of any one of claims 18 to 24, wherein the polypropylene has a Pr of 0.45-0.55.
